(19) United States
(12) Patent Application Publication
(10) Pub. No.: US 2026/0340259 A1
(43) Pub. Date: Oct. 29, 2026

(54) INFORMATION PROCESSING METHOD

(71) Applicant: Semiconductor Energy Laboratory Co., Ltd., Atsugi-shi (JP)

(72) Inventors: Kengo AKIMOTO, Isehara (JP); Junpei MOMO, Sagamihara (JP)

(21) Appl. No.: 19/650,511

(22) Filed: Apr. 17, 2026

(30) Foreign Application Priority Data
Apr. 29, 2025 (JP) 2025-075038

(51) Int. Cl. G06F 40/117

(52) U.S. Cl. CPC G06F 40/117

(57) ABSTRACT

An information processing device capable of performing searches is provided. After a document and a drawing are received, a language model assigns a start tag to the drawing. The start tag is generated on the basis of the document and represents a term related to the drawing. Next, the language model assigns an additional tag or a "none" tag to the drawing. The "none" tag indicates that terms related to the drawing are not present in additional tag candidates. When a "none" tag is assigned to the drawing, the language model presents a new additional tag candidate.

### BACKGROUND OF THE INVENTION

### 1. Field of the Invention

One embodiment of the present invention relates to an information processing device. Another embodiment of the present invention relates to an information processing method using an information processing device. Another embodiment of the present invention relates to an information processing system including an information processing device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Specific examples of the technical field of one embodiment of the present invention disclosed in this specification include an information processing device, a semiconductor device, a memory device, a driving method thereof, and a manufacturing method thereof.

### 2. DESCRIPTION OF THE RELATED ART

Prior art search before application for an invention can reveal if there are relevant intellectual property rights. Prior art documents such as domestic and foreign patent documents and papers obtained through the prior art search are helpful in confirming the novelty and non-obviousness of the invention and determining whether to file the application. In addition, prior art document invalidity search can reveal whether there is a possibility of invalidation of the patent right owned by an applicant or whether the patent rights owned by others can be rendered invalidation.

The prior art search can be performed, for example, by retrieval of prior art documents that disclose a drawing similar to a drawing embodying the technology to be filed. Specifically, when a user inputs a drawing to a search system, for example, it is possible to retrieve prior art documents including a drawing similar to the input drawing.

An image similar to an input image can be retrieved using an artificial neural network (ANN, which is hereinafter also simply referred to as a neural network), for example. Patent Document 1, for example, discloses a method for determining similarity between images by using a neural network.

In recent years, language models using neural networks have been actively developed, and large language models (LLM) in particular have attracted attention. A large language model is a natural language processing model learned using a large amount of data. With a large language model, a communication model that gives an answer to a user's instruction can be achieved, for example. In Non-Patent Document 1, generative pre-trained transformer 4 (GPT-4, registered trademark) is disclosed as a large language model, and ChatGPT is disclosed as a communication model. Other examples of large language models include LaMDA (Language Model for Dialogue Applications), PaLM (Pathways Language Model), Llama2, and Llama3.

### References

[Patent Document 1] Japanese Published Patent Application No. 2017-207947

[Non-Patent Document 1] Summary of ChatGPT/GPT-4 Research and Perspective Towards the Future of Large Language Models, Yiheng Liu et al., submitted on 4 April, 2023 [online], Internet URL: https://arxiv.org/abs/2304.01852

### SUMMARY OF THE INVENTION

However, with the above-described method, it is difficult to perform a search in consideration of the meaning represented by a drawing. An example of a method for performing a search in consideration of the meaning represented by a drawing includes a method in which a tag indicating a term related to the drawing is assigned to the drawing. Here, by assigning a plurality of tags to one drawing and representing these tags in a tree structure, tagging that enables comprehensive coverage of terms related to the drawing is possible. However, comprehensive manual tagging requires an enormous amount of workload.

In view of the above, an object of one embodiment of the present invention is to provide an information processing device, an information processing method, and an information processing system that are capable of assigning tags so as to comprehensively cover terms related to a drawing with a small workload. Another object of one embodiment of the present invention is to provide an information processing device, an information processing method, and an information processing system that are capable of performing highly convenient searches.

Another object of one embodiment of the present invention is to provide an information processing device, an information processing method, and an information processing system that are highly convenient and useful. Another object of one embodiment of the present invention is to provide a novel information processing device, a novel information processing method, and a novel information processing system.

Note that the description of these objects does not preclude the existence of other objects. One embodiment of the present invention does not need to achieve all these objects. Other objects will be apparent from and can be derived from the description of the specification, the drawings, the claims, and the like.

One embodiment of the present invention is an information processing method including a first to fourth steps. In the first step, a drawing and a document are received. In the second step, a first prompt for assigning a start tag to the drawing on the basis of the document is created and transmitted to a language model. The start tag represents a term related to the drawing. In the third step, a second prompt for assigning a "none" tag or at least one of additional tag candidates based on the start tag to the drawing is created and transmitted to the language model. The "none" tag indicates that terms related to the drawing are absent from the additional tag candidates. When the "none" tag is assigned to the drawing, a third prompt for presenting a new additional tag candidate on the basis of the start tag is created and transmitted to the language model in the fourth step, and then the third step is performed.

The above embodiment may include a fifth to eighth steps. In the fifth step, a reference numeral is obtained from the drawing. In the sixth step, a name of a component denoted by the reference numeral is obtained from the document. In the seventh step, text including the name and the reference numeral is obtained from the document. In the eighth step, a representation is obtained by using a graph description language on the basis of the reference numeral, the name, and the text. The fifth to eighth steps may be performed after the first step and before the second step. The representation may represent a graph including at least two nodes and at least one edge. The node may represent the component. The edge may represent a relation between two of the nodes. The first prompt may include the text and the representation.

In the above embodiment, the representation may be obtained in the eighth step by creating a fourth prompt for generating the representation and transmitting the fourth prompt to the language model.

Another embodiment of the present invention is an information processing method including a first to eighth steps. In the first step, a drawing and a document are received. In the second step, a first prompt for assigning a start tag to the drawing on the basis of the document is created and transmitted to a language model. The start tag represents a term related to the drawing. In the third step, a second prompt for assigning a first "none" tag or at least one of first additional tag candidates based on the start tag to the drawing is created and transmitted to the language model. The first "none" tag indicates that terms related to the drawing are absent from the first additional tag candidates. When at least one of the first additional tag candidates is assigned as an additional tag to the drawing, a third prompt for assigning a second "none" tag or at least one of second additional tag candidates based on the additional tag to the drawing is created and transmitted to the language model in the fourth step. The second "none" tag indicates that the terms related to the drawing are absent from the second additional tag candidates. When the first "none" tag is assigned to the drawing, a fourth prompt for presenting third additional tag candidates on the basis of the start tag is created and transmitted to the language model in the fifth step, and then a fifth prompt for assigning a third "none" tag or at least one of the third additional tag candidates is created and transmitted to the language model in the sixth step. The third "none" tag indicates that the terms related to the drawing are absent from the third additional tag candidates. When the second "none" tag is assigned to the drawing, a sixth prompt for presenting fourth additional tag candidates on the basis of the additional tag is created and transmitted to the language model in the seventh step, and then a seventh prompt for assigning a fourth "none" tag or at least one of the fourth additional tag candidates is created and transmitted to the language model in the eighth step. The fourth "none" tag indicates that the terms related to the drawing are absent from the fourth additional tag candidates.

The above embodiment may include a ninth to twelfth steps. In the ninth step, a reference numeral is obtained from the drawing. In the tenth step, a name of a component denoted by the reference numeral is obtained from the document. In the eleventh step, text including the name and the reference numeral is obtained from the document. In the twelfth step, a representation is obtained by using a graph description language on the basis of the reference numeral, the name, and the text. The ninth to twelfth steps may be performed after the first step and before the second step. The representation may represent a graph including at least two nodes and at least one edge. The node may represent the component. The edge may represent a relation between two of the nodes. The first prompt may include the text and the representation.

In the above embodiment, the representation may be obtained in the twelfth step by creating an eighth prompt for generating the representation and transmitting the eighth prompt to the language model.

Another embodiment of the present invention is an information processing method including a first to seventh steps. In the first step, a drawing and a document are received. In the second step, a first prompt for assigning a start tag to the drawing is created on the basis of the document and is transmitted to a language model. The start tag represents a term related to the drawing. In the third step, a second prompt for assigning a first "none" tag or at least one of first additional tag candidates based on the start tag to the drawing is created and transmitted to the language model. The first "none" tag indicates that terms related to the drawing are absent from the first additional tag candidates. When the first "none" tag is assigned to the drawing, the fourth to seventh steps are performed. In the fourth step, first text is obtained from the document. In the fifth step, a third prompt for presenting a first tagging perspective on the basis of the first text is created and transmitted to the language model. In the sixth step, a fourth prompt for presenting, on the basis of the first tagging perspective, at least one first tag candidate in a tree structure using one of the tags assigned to the drawing as a first root node is created and transmitted to the language model. In the seventh step, a fifth prompt for assigning at least one second additional tag candidate represented as a child node of the first root node to the drawing as a first additional tag is created and transmitted to the language model.

In the above embodiment, the second prompt may be a prompt for assigning at least one of the first additional tag candidates or the first "none" tag to the drawing on the basis of a second tagging perspective different from the first tagging perspective. Instruction text for the third prompt may include a command not to incorporate the second tagging perspective in the first tagging perspective.

The above embodiment may include an eighth to twelfth steps. In the eighth step, a sixth prompt for assigning a second "none" tag or at least one of third additional tag candidates represented as child nodes of the first additional node to the drawing is created and transmitted to the language model. The second "none" tag indicates that terms related to the drawing are absent from the third additional tag candidates. When the second "none" tag is assigned to the drawing, the ninth to twelfth steps may be performed. In the ninth step, the first text is obtained. In the tenth step, a seventh prompt for presenting a second tagging perspective on the basis of the first text is created and transmitted to the language model. In the eleventh step, an eighth prompt for presenting, on the basis of the second tagging perspective, at least one second tag candidate in a tree structure using one of the tags assigned to the drawing as a second root node is created and transmitted to the language model. In the twelfth step, a ninth prompt for assigning at least one fourth additional tag candidate represented as a child node of the second root node to the drawing as a second additional tag is created and transmitted to the language model.

In the above embodiment, the second prompt may be a prompt for assigning at least one of the first additional tag candidates or the first "none" tag to the drawing on the basis of a third tagging perspective different from the first tagging perspective and the second tagging perspective. Instruction text for the third prompt may include a command not to incorporate the third tagging perspective in the first tagging perspective. Instruction text for the seventh prompt may include a command not to incorporate the first tagging perspective and the third tagging perspective in the second tagging perspective.

The above embodiment may include an eighth to eleventh steps. In the eighth step, a reference numeral is obtained from the drawing. In the ninth step, a name of a component denoted by the reference numeral is obtained from the document. In the tenth step, second text including the name and the reference numeral is obtained from the document. In the eleventh step, a representation is obtained by using a graph description language on the basis of the reference numeral, the name, and the second text. The eighth to eleventh steps may be performed after the first step and before the second step. The representation may represent a graph including at least two nodes and at least one edge. The node may represent the component. The edge may represent a relation between two of the nodes. The first prompt may include the second text and the representation.

In the above embodiment, the first text may include the second text.

In the above embodiment, the first text may include text describing a purpose.

In the above embodiment, the document may be a specification for a patent application, the drawing may be a drawing for the patent application, and the text describing the purpose may be a section Problem to be Solved by the Invention.

In the above embodiment, the representation may be obtained in the eleventh step by creating a sixth prompt for generating the representation and transmitting the sixth prompt to the language model.

In the above embodiment, the graph description language may be a DOT language.

One embodiment of the present invention can provide an information processing device, an information processing method, and an information processing system that are capable of assigning tags so as to comprehensively cover terms related to a drawing with a small workload. Another embodiment of the present invention can provide an information processing device, an information processing method, and an information processing system that are capable of performing highly convenient searches.

Another embodiment of the present invention can provide an information processing device, an information processing method, and an information processing system that are highly convenient and useful. Another embodiment of the present invention can provide a novel information processing device, a novel information processing method, and a novel information processing system.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

### In the accompanying drawings

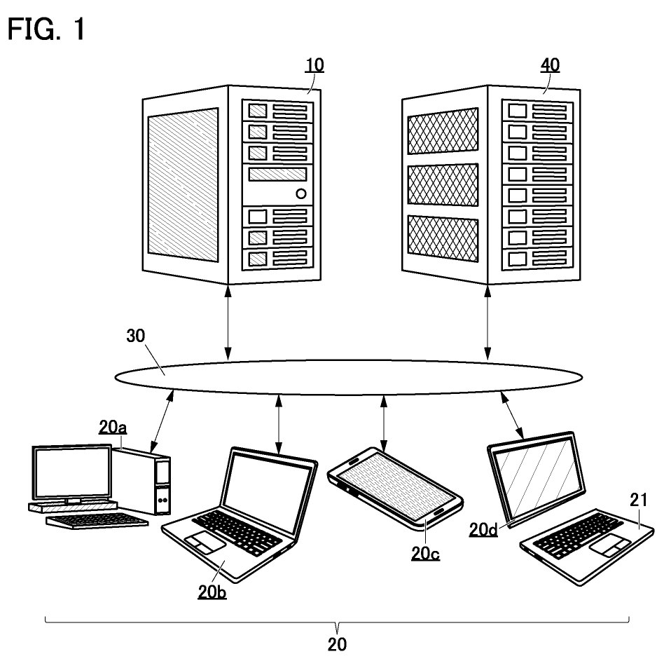

FIG. 1 is a schematic diagram illustrating an example of an information processing system;

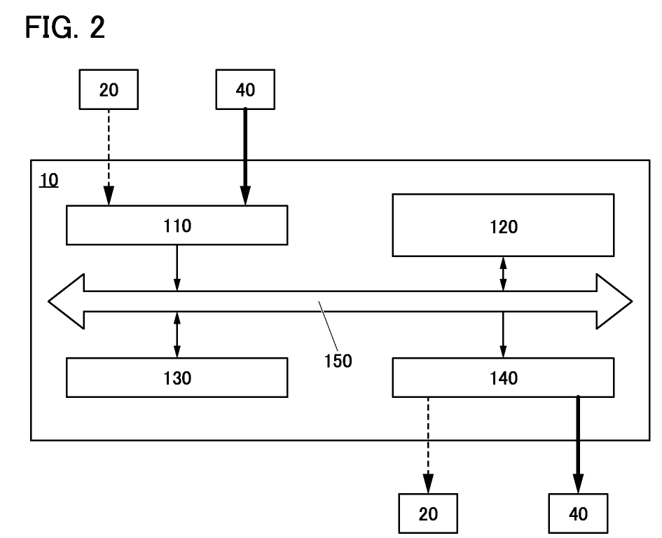

FIG. 2 is a block diagram illustrating an example of an information processing system;

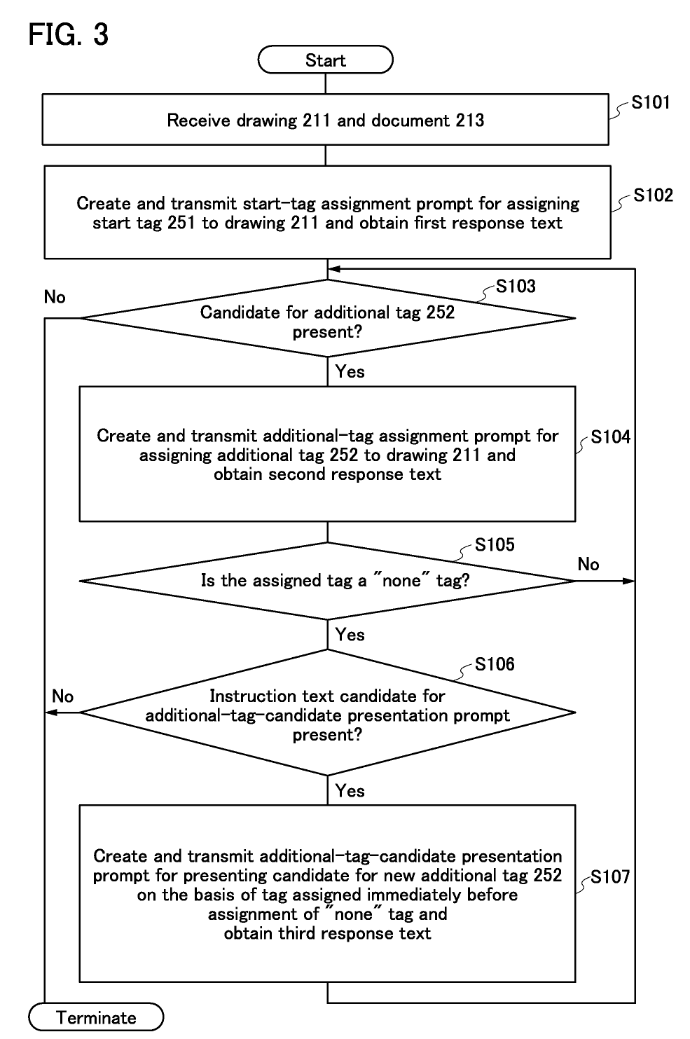

FIG. 3 is a flow chart showing an example of an information processing method;

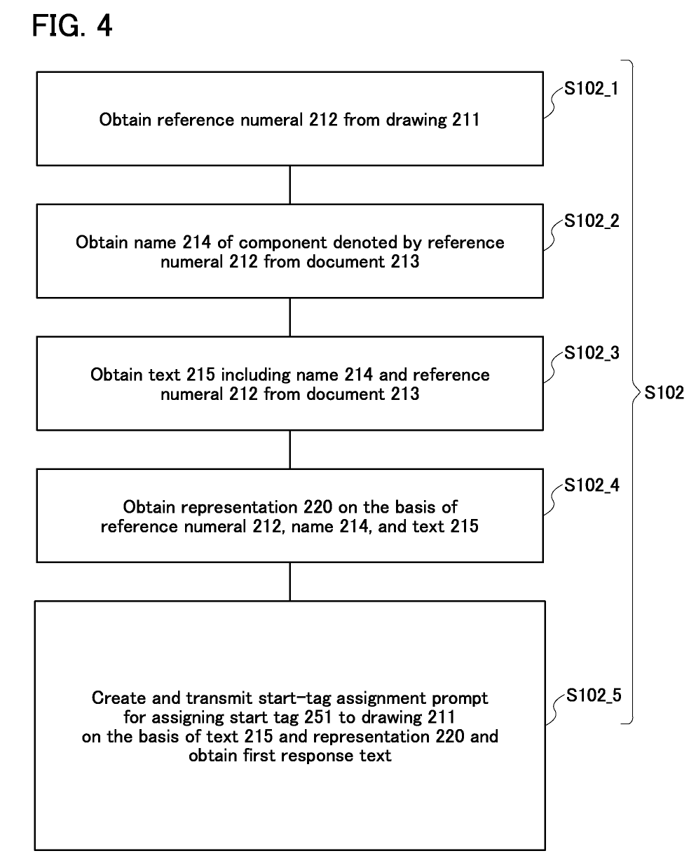

FIG. 4 is a flow chart showing an example of an information processing method;

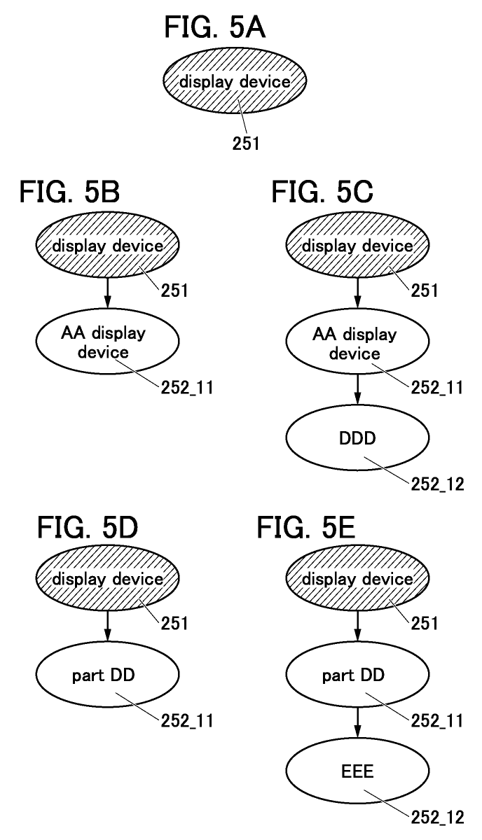

FIGS. 5A to 5E are schematic diagrams illustrating tag assignment to a drawing;

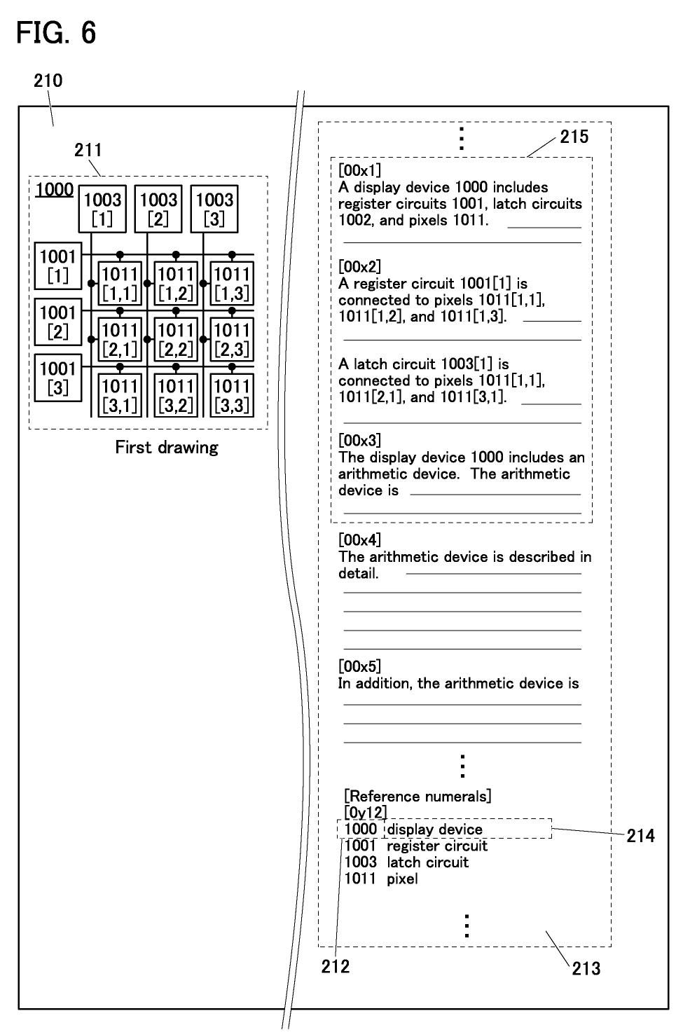

FIG. 6 is a schematic diagram illustrating an example of data;

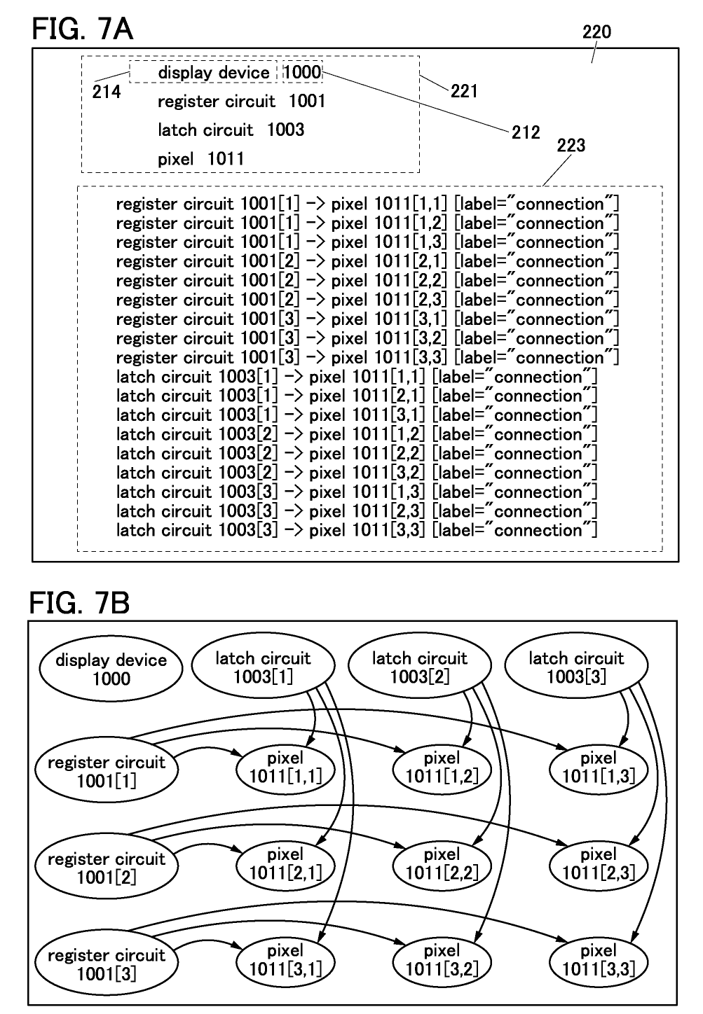

FIGS. 7A and 7B are schematic diagrams illustrating a representation in a graph description language;

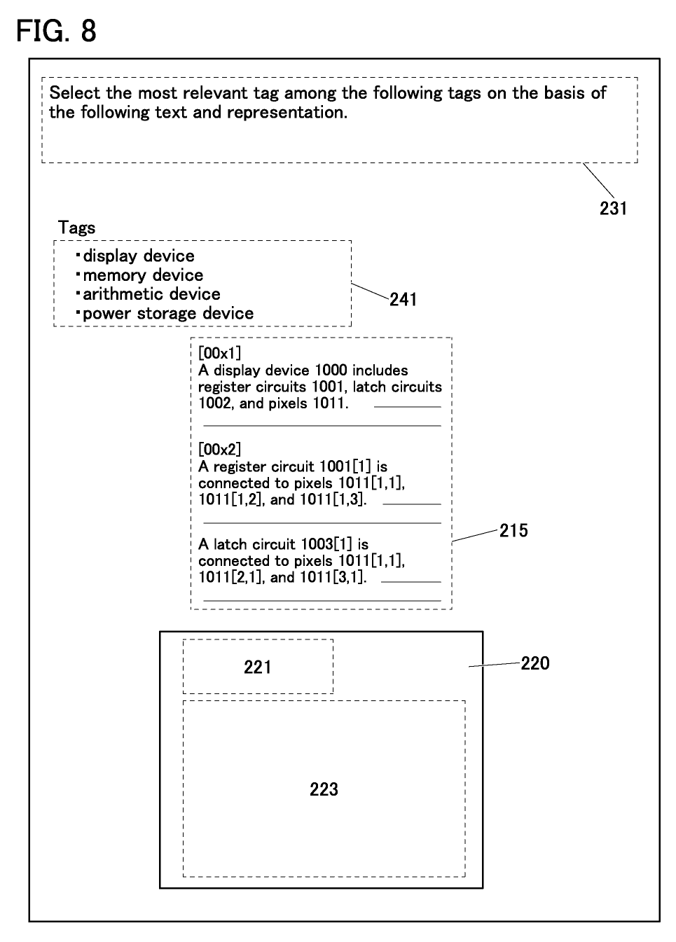

FIG. 8 is a schematic diagram illustrating an example of a prompt;

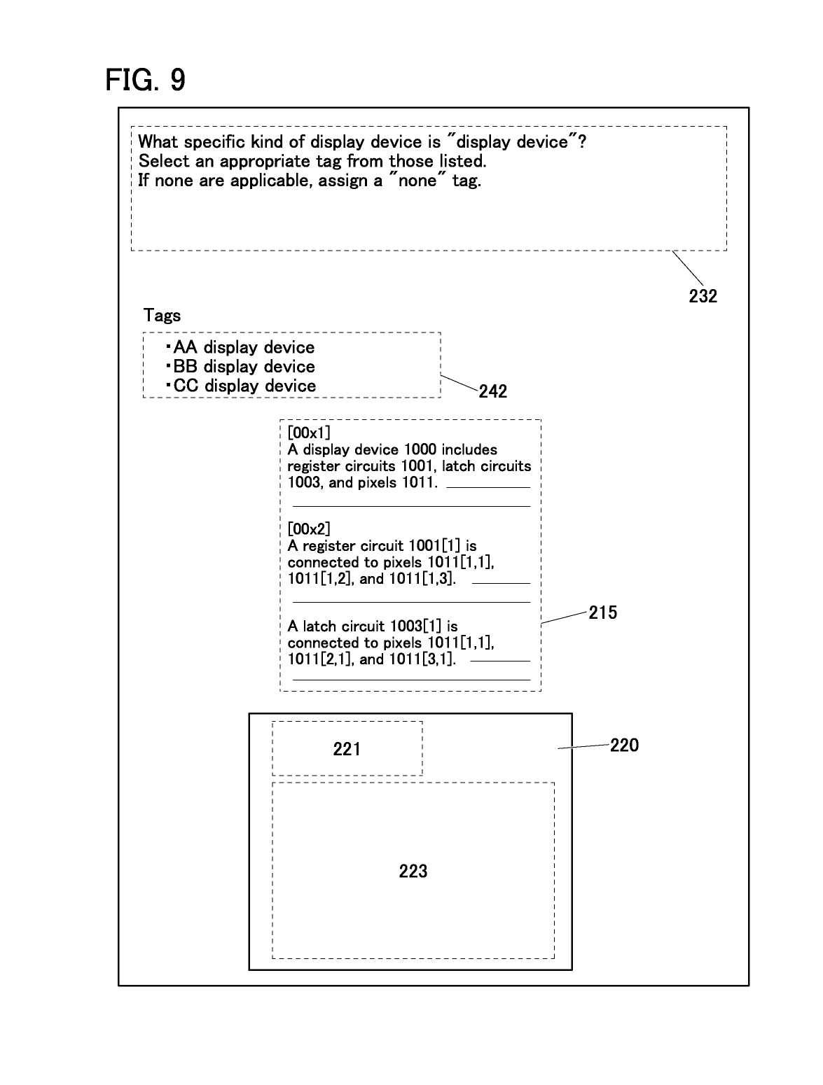

FIG. 9 is a schematic diagram illustrating an example of a prompt;

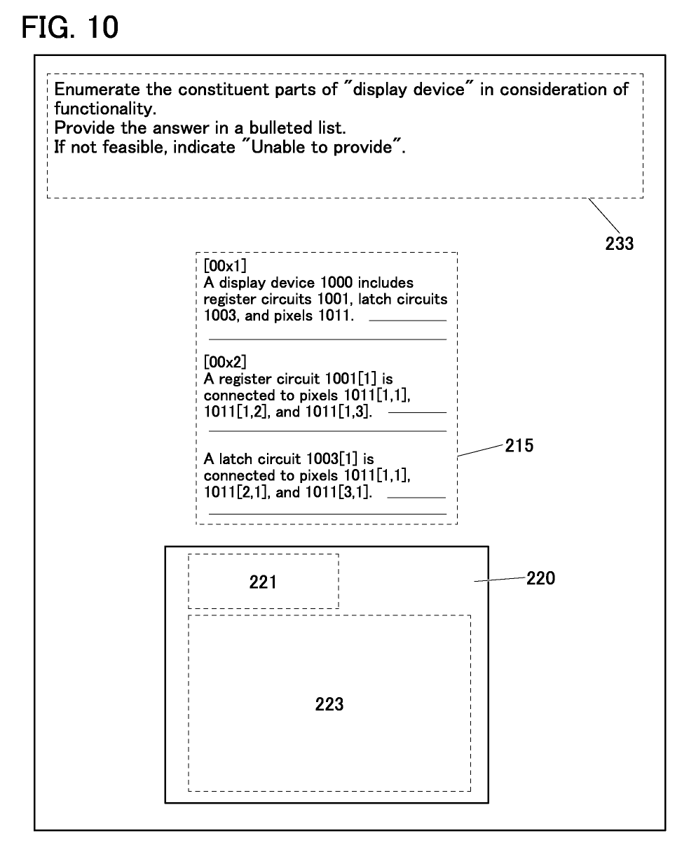

FIG. 10 is a schematic diagram illustrating an example of a prompt;

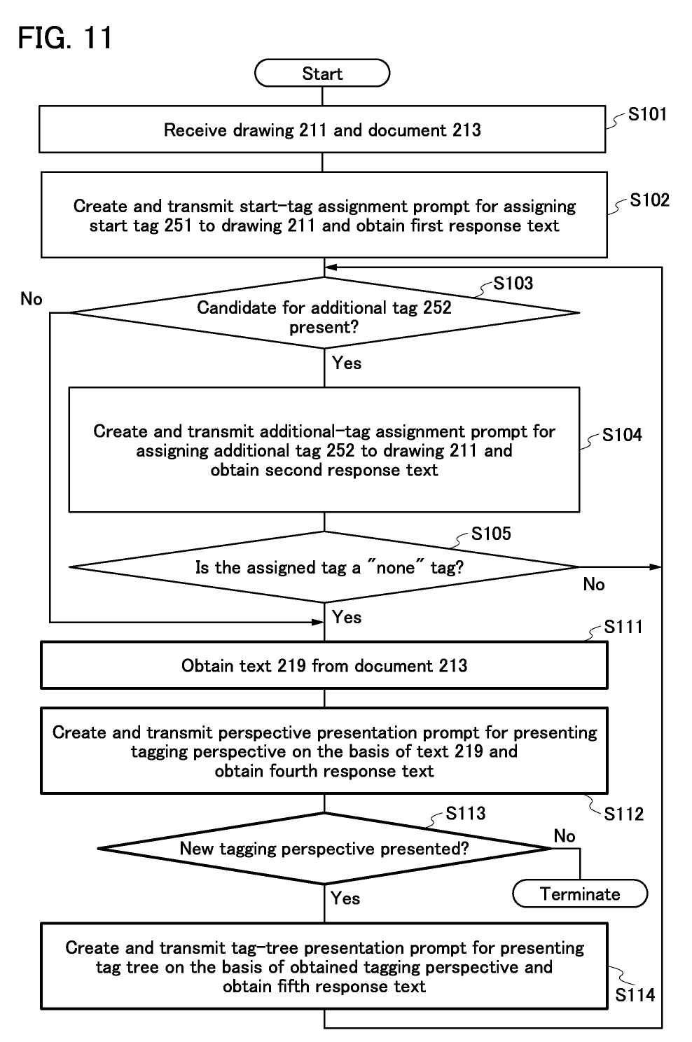

FIG. 11 is a flow chart showing an example of an information processing method;

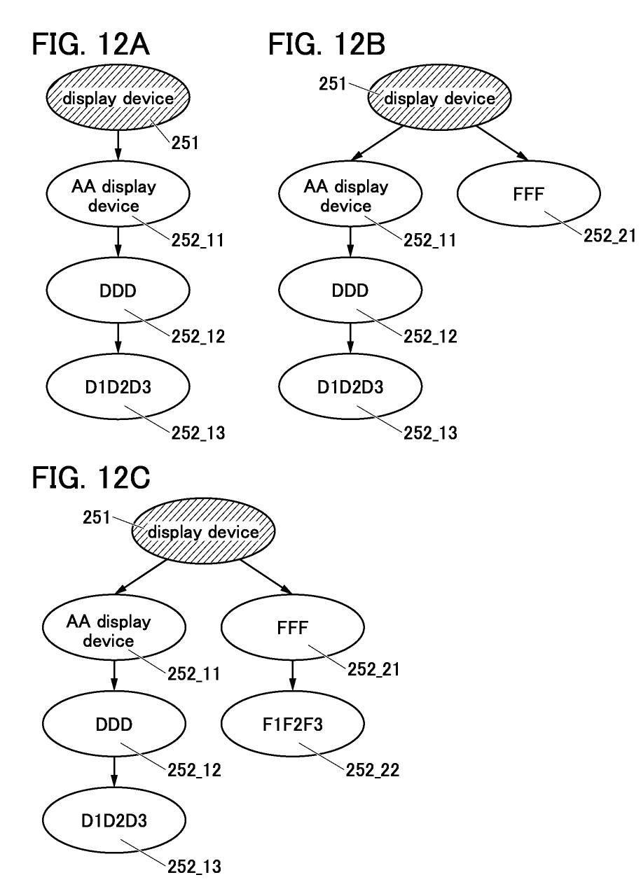

FIGS. 12A to 12C are schematic diagrams illustrating tag assignment to a drawing;

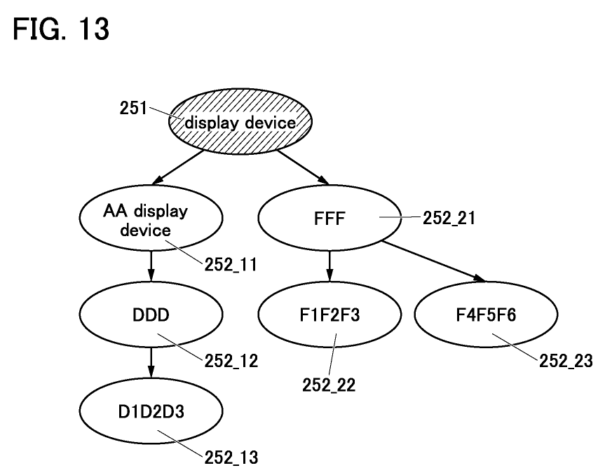

FIG. 13 is a schematic diagram illustrating tag assignment to a drawing;

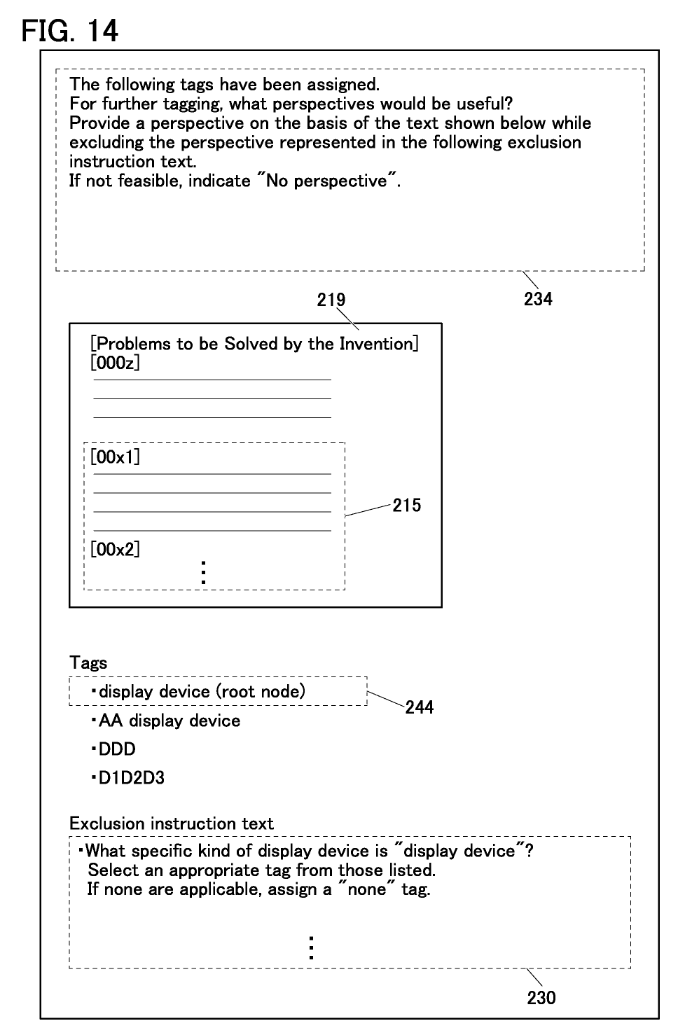

FIG. 14 is a schematic diagram illustrating an example of a prompt; and

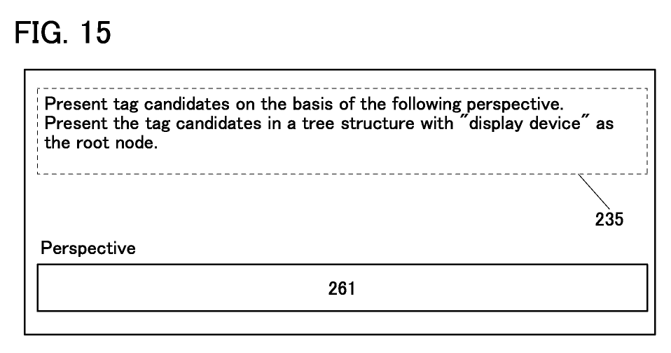

FIG. 15 is a schematic diagram illustrating an example of a prompt.

### DETAILED DESCRIPTION OF THE INVENTION

Embodiment will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiment. Note that in structures of the invention described below, the same portions or portions having similar functions are denoted by the same reference numerals in different drawings, and the description thereof is not repeated.

Although a block diagram in which components are classified by their functions and shown as independent blocks is shown in drawings attached to this specification, it is sometimes difficult to completely separate actual components according to their functions and one component can relate to a plurality of functions.

In this specification and the like, the terms "first" and "second" are sometimes used for easy understanding of the technical contents or identification of components. Thus, the terms "first" and "second" do not limit the number of components. Moreover, the terms "first" and "second" do not limit the order of components. In addition, the terms such as "first" and "second" or identification numerals used in this specification do not correspond to the terms or the identification numerals in the scope of claims of this application in some cases.

### Embodiment

This embodiment will describe an information processing system of one embodiment of the present invention. This embodiment will also describe an information processing device included in the information processing system and an information processing method using the information processing system.

In one embodiment of the present invention, a tag group having a tree structure is assigned to a drawing. Thus, a database including the drawing and the tags assigned to the drawing is created. The drawing can be, for example, a drawing for an application related to intellectual property rights. The drawing can be, for example, a drawing for a patent application or a drawing for a utility model registration application. The tags assigned to the drawing indicate terms related to the drawing.

A tree structure is a graph representing hierarchical data. A graph is a data structure that consists of nodes and edges, where each edge connects two nodes. In the tree structure, the topmost node is referred to as a root node. In the tree-structured tag group, one node represents one tag.

In this specification and the like, the term "tree structure" includes both a branched structure and an unbranched structure.

In this specification and the like, a tag group having a tree structure is also referred to as a tag tree.

In the information processing system of one embodiment of the present invention, first, a tag serving as a root node is assigned to a drawing by using a language model. The tag is referred to as a start tag. Next, a tag serving as a child tag of the root node is assigned by using the language model. After that, a tag serving as a child node of the node representing the obtained tag is assigned by using the language model. By repeating the above, a tag group having a tree structure can be assigned to the drawing. Here, the tags other than the start tag are tags added on the basis of the start tag. Thus, the tags other than the start tag are referred to as additional tags.

As described above, in the information processing system of one embodiment of the present invention, a tag group having a tree structure is assigned to a drawing with the use of the language model. Accordingly, the tags can be assigned with a smaller workload than in the case where a tag group having a tree structure is assigned manually, for example. Moreover, tagging by the information processing system of one embodiment of the present invention enables comprehensive coverage of terms related to the drawing, unlike non-hierarchical tagging, for example.

The user of the information processing system of one embodiment of the present invention can search for a drawing with the use of tags. For example, a drawing to which a tag including a keyword specified by the user is assigned can be retrieved from the above-described database and presented to the user. As described above, tags can be assigned to the drawing so as to comprehensively cover terms related to the drawing. Accordingly, the information processing system of one embodiment of the present invention can perform highly convenient searches.

Here, the information processing system of one embodiment of the present invention can be regarded as including a tagging system and a search system. In this case, the tagging system has a function of performing the above-described tag assignment, specifically, assignment of a tree-structured tag group to a drawing. The search system has a function of performing retrieval using the assigned tag. Note that the tagging system may be considered to be the information processing system of one embodiment of the present invention.

Accordingly, one embodiment of the present invention can provide an information processing system that is highly convenient and useful. One embodiment of the present invention can also provide an information processing device included in the information processing system and an information processing method using the information processing system.

### Structure example 1 of information processing system

FIG. 1 is a schematic diagram illustrating a structure example of the information processing system of one embodiment of the present invention. The information processing system of one embodiment of the present invention includes an information processing device 10 and an information processing device 40. The information processing device 10 and the information processing device 40 are connected to each other via a network 30 and can transmit and receive data.

The information processing device 40 has a function of performing processing using a language model. The language model has a function of generating response text on the basis of a prompt. The prompt is regarded as an input sentence for causing the language model to perform an intended operation. The prompt is supplied from the information processing device 10 to the information processing device 40, for example. The response text generated by the language model is supplied from the information processing device 40 to the information processing device 10, for example. Note that the information processing device 10 may have a function of performing processing using a language model.

The information processing system of one embodiment of the present invention may be configured such that the user can directly operate the information processing device 10 to input a document or the like, or may be configured such that the user can input a document or the like with an information terminal 20 connected to the information processing device 10 via the network 30, as illustrated in FIG. 1.

Structure examples of the information processing device 10, the information processing device 40, the information terminal 20, and the network 30 are described below.

### Structure example of information processing device 10

FIG. 2 is a block diagram illustrating a structure example of the information processing device 10. The information processing device 10 includes a reception unit 110, a memory unit 120, a processing unit 130, an output unit 140, and a transmission path 150. FIG. 2 also illustrates the information terminal 20 and the information processing device 40.

### Reception unit 110

The reception unit 110 has a function of receiving data from the outside of the information processing device 10. The reception unit 110 has a function of receiving data representing a document or a drawing, for example, from the information terminal 20. The reception unit 110 has a function of receiving data representing response text, for example, from the information processing device 40.

The reception unit 110 has a function of supplying the received data to one or both of the memory unit 120 and the processing unit 130 via the transmission path 150. As the reception unit 110, a device such as a wired communication port, a wireless communication port, or an optical communication port can be used, for example.

### Memory unit 120

The memory unit 120 has a function of storing a program to be executed by the processing unit 130. The memory unit 120 may have a function of storing data created by the processing unit 130 (e.g., an arithmetic result, an analysis result, and an inference result), data received by the reception unit 110, and the like.

The memory unit 120 may include a database. The information processing device 10 may include another database different from the memory unit 120. The information processing device 10 may have a function of extracting data from a database that is placed outside the memory unit 120, the information processing device 10, or the information processing system. The information processing device 10 may have a function of extracting data from both its own database and an external database.

The memory unit 120 stores a plurality of tags. Each tag indicates a term, for example. The information processing system of one embodiment of the present invention assigns some of the tags stored in the memory unit 120, for example, to a drawing. Specifically, the information processing system assigns a tag stored in the memory unit 120, for example, to a drawing received by the reception unit 110. A tag to be linked to the drawing is selected by a language model.

Here, the plurality of tags stored in the memory unit 120 can be grouped. The group can be represented by a hierarchical structure. Accordingly, the plurality of tags stored in the memory unit 120 can be represented by one or more tag trees. In other words, the memory unit 120 stores a tag tree, for example, a plurality of tag trees. The tag tree(s) can be created by the user of the information processing system, for example.

In an information processing method of one embodiment of the present invention, a database including a drawing and tags assigned to the drawing is created. The database can be included in the memory unit 120, for example.

The memory unit 120 has a function of storing instruction text in a prompt. Note that the details of instruction text in a prompt will be described later in <Information processing method 1> and <Information processing method 2>.

One or both of a storage and a file server can be used as the memory unit 120. In addition, a database that stores paths of files retained in the file server can be used as the memory unit 120.

### Processing unit 130

The processing unit 130 has a function of performing processing such as arithmetic operation, analysis, and inference with the use of data supplied from one or both of the reception unit 110 and the memory unit 120. The processing unit 130 can supply created data (e.g., an arithmetic result, an analysis result, and an inference result) to one or both of the memory unit 120 and the output unit 140. The processing unit 130 has a function of creating a prompt. Note that the processing unit 130 may have a function of performing processing using a language model.

The processing unit 130 has a function of obtaining data from the memory unit 120. The processing unit 130 may have a function of storing or registering data in the memory unit 120.

### Output unit 140

The output unit 140 has a function of outputting at least one of the arithmetic result, the analysis result, and the inference result in the processing unit 130 to the outside of the information processing device 10. As the output unit 140, a device such as a wired communication port, a wireless communication port, or an optical communication port can be used, for example.

For example, the output unit 140 has a function of supplying data representing a prompt or the like to the information processing device 40.

### Transmission path 150

The transmission path 150 has a function of transmitting data. Data transmission and reception among the reception unit 110, the memory unit 120, the processing unit 130, and the output unit 140 can be performed via the transmission path 150. As the transmission path 150, a bus line on a motherboard, a wired communication cable, or an optical communication cable can be used, for example.

### Structure example of information processing device 40

The information processing device 40 can process the received data and transmit the processing result. For example, the information processing device 40 can perform arithmetic processing or the like using data supplied from the information processing device 10. The information processing device 40 can supply the processing result to the information processing device 10. Accordingly, arithmetic processing loads on the information processing device 10 can be reduced.

The information processing device 40 can perform processing using a language model, as described above. For example, the information processing device 40 can execute processing using a language model such as BERT or T5. The information processing device 40 can also perform processing using a language-model-based model (e.g., a text generation model or a conversation model).

The language model generates response text on the basis of a prompt, as described above. For example, a prompt created by the processing unit 130 is supplied to the language model of the information processing device 40 through the output unit 140. Response text generated by the language model is supplied to one or both of the memory unit 120 and the output unit 140, for example, through the reception unit 110.

The information processing device 40 can execute processing using a general-purpose language processing model capable of performing a variety of natural language processing tasks.

The information processing device 40 is a large computer such as a server computer or a supercomputer. The information processing device 40 preferably has a function of a parallel computer. When the information processing device 40 is used as a parallel computer, large-scale computation necessary for artificial intelligence (AI) learning and inference can be performed, for example.

Note that the information processing device 40 is a computer having higher processing power than the information processing device 10. For example, in the case where both the information processing device 10 and the information processing device 40 have a function of a parallel computer, the information processing device 40 having higher processing power than the information processing device 10 enables larger-scale computation. For another example, in the case where both the information processing device 10 and the information processing device 40 can perform processing using a language-model-based model, the information processing device 40 can handle a larger-scale model for processing than the information processing device 10.

Note that a service provider does not necessarily have its own information processing device 40. For example, a service provider can utilize part of the service that another company or the like provides using the information processing device 40.

### Structure example of information terminal 20

The information terminal 20 can receive data input by the user of the information processing system of one embodiment of the present invention. The information terminal 20 can present data output from the information processing system of one embodiment of the present invention to the user by displaying the data on a display portion of the information terminal 20. Alternatively, the information terminal 20 can present data output from the information processing system of one embodiment of the present invention to the user by printing the data by a printing unit of the information terminal 20.

The information terminal 20 can supply, to the information processing device 10, data received from the user. The information terminal 20 can provide the user with data supplied from the information processing device 10.

The information terminal 20 can supply, to the information processing device 10, data created on the basis of data received from the user. The information terminal 20 can provide the user with data created on the basis of data supplied from the information processing device 10.

Dedicated application software and a web browser, for example, are installed on the information terminal 20. The user can access the information processing device 10 via the dedicated application software, the web browser, or the like. Thus, the user can enjoy a service based on the information processing system of one embodiment of the present invention by using a computer whose processing power is lower than that of the information processing device 10, for example, as the information terminal 20.

The information terminal 20 can also be referred to as a client computer or the like. Any type of the information terminal 20 is an information terminal used by the user of the information processing system of one embodiment of the present invention.

For example, a desktop computer 20a, a notebook computer 20b, a smartphone 20c, or a tablet computer 20d can be used as the information terminal 20. Note that the tablet computer 20dcan also be used as a notebook computer when connected to a housing 21 including a keyboard.

### Network 30

The network 30 connects the information processing device 10 and the information processing device 40. The network 30 also connects a plurality of the information terminals 20 to the information processing device 10. Thus, input data and processed data can be transmitted and received between the information processing devices 10 and 40 and between the information terminals 20 and the information processing device 10. Furthermore, information processing loads can be dispersed.

An information processing method using the information processing system illustrated in FIGS. 1 and 2 described below. Specifically, a method for operating the information processing device 10 is described.

### Information processing method 1

FIGS. 3 and 4 are flow charts showing an example of the information processing method of one embodiment of the present invention. FIGS. 3 and 4 show an example of processes executed by the information processing device 10.

FIG. 3 shows Step S101 to Step S107. FIG. 4 shows Step S102_1 to Step S102_5 as an example of more detailed processes in Step S102.

In the information processing method shown in FIGS. 3 and 4 , a tag group having a tree structure is assigned to a later-described drawing 211. FIGS. 5A to 5E are schematic diagrams for describing tag assignment to the drawing 211.

When the information processing method of one embodiment of the present invention "starts", the reception unit 110 receives the drawing 211 and a document 213 in Step S101. Specifically, when a user of the information terminal 20 inputs data including the drawing 211 and the document 213 to the information processing device 10, the reception unit 110 receives the data.

FIG. 6 is a schematic diagram illustrating an example of data 210 that is input to the information processing device 10 in Step S101. In the example illustrated in FIG. 6, the data 210 includes the drawing 211 and the document 213.

The data 210 can be data representing a document for an application related to intellectual property rights. Examples of the application include a patent application and a utility model registration application. In such a case, the document 213 can be a specification. Note that the data 210 may alternatively be a paper, a journal, or a book, for example. The document represented by the data 210 may or may not be publicly known.

In this specification and the like, a patent application includes an international patent application. A utility model registration application includes an international utility model registration application. An international patent application refers to an international application that has entered the national (or regional) phase as a patent application. An international utility model registration application refers to an international application that has entered the national (or regional) phase as a utility model registration application. Here, an international application refers to, for example, an application based on the Patent Cooperation Treaty (PCT).

FIG. 6 illustrates a first drawing as the drawing 211. Note that the data 210 can include a plurality of the drawing 211. For example, in the case where the data 210 includes two drawing 211, the data 210 includes a first drawing and a second drawing.

The drawing 211 includes reference numerals. The reference numerals are assigned to components illustrated in the drawing 211. FIG. 6 illustrates an example in which the drawing 211 includes reference numerals "1000", "1001[1]", "1001[2]", "1001[3]", "1003[1]", "1003[2]", "1003[3]", "1011[1,1]", "1011[1,2]", "1011[1,3]", "1011[2,1]", "1011[2,2]", "1011[2,3]", "1011[3,1]", "1011[3,2]", and "1011[3,3]". Here, "[ ]" are identification signs. The reference numeral and identification signs can be represented as text, for example. Alternatively, they may be represented as an image.

FIG. 6 illustrates a block diagram as an example of the drawing 211, specifically, the first drawing. The block diagram illustrates a display device that is denoted by the reference numeral "1000". Three register circuits included in the display device are denoted by the reference numerals "1001[1]", "1001[2]", and "1001[3]". Three latch circuits are denoted by the reference numerals "1003[1]", "1003[2]", and "1003[3]". Pixels in three rows and three columns are denoted by the reference numerals "1011[1,1]", "1011[1,2]", "1011[1,3]", "1011[2,1]", "1011[2,2]", "1011[2,3]", "1011[3,1]", "1011[3,2]", and "1011[3,3]". Note that the drawing 211 is not limited to a block diagram. For example, the drawing 211 may be a circuit diagram. Alternatively, the drawing 211 may be a cross-sectional view of a device such as a semiconductor device or a drawing showing a method. The method includes a simple method and a method for producing a product.

The document 213 is represented by text. In the example illustrated in FIG. 6, the text included in the document 213 is divided into a plurality of paragraphs. The document 213 includes the description of the drawing 211. The description is made using the reference numerals included in the drawing 211. Moreover, the document 213 includes the section [Reference numerals]. In the section [Reference numerals], the names of the components denoted by the reference numerals included in the drawing 211 are listed.

FIG. 6 shows a paragraph [00x1], a paragraph [00x2], a paragraph [00x3], a paragraph [00x4], a paragraph [00x5], and a paragraph [0y12] included in the document 213. The paragraph [00x1] includes a sentence "A display device 1000 includes register circuits 1001, latch circuits 1003, and pixels 1011". The paragraph [00x2] includes sentences "A register circuit 1001[1] is connected to pixels 1011[1,1], 1011[1,2], and 1011[1,3]." and "A latch circuit 1003[1] is connected to pixels 1011[1,1], 1011[2,1], and 1011[3,1]." Note that the paragraph [00x2] also includes sentences that describe the connection relation between the pixels 1011 and each of a register circuit 1001[2], a register circuit 1001[3], a latch circuit 1003[2], and a latch circuit 1003[3].

The paragraph [00x3] includes text "The display device 1000 includes an arithmetic device. The arithmetic device is". The paragraph [00x4] includes a sentence "The arithmetic device is described in detail". The paragraph [00x5] includes a sentence fragment "In addition, the arithmetic device is".

The paragraph [0y12] corresponds to the section [Reference numerals]. FIG. 6 shows "1000 display device", "1001 register circuit", "1003 latch circuit", and "1011 pixel" as an example of the section [Reference numerals]. In the section [Reference numerals] in FIG. 6, identification signs are omitted but may alternatively be provided.

Next, in Step S102 shown in FIG. 3, the processing unit 130 creates a start-tag assignment prompt and transmits the prompt to the information processing device 40 through the output unit 140. The start-tag assignment prompt is specifically transmitted to the language model of the information processing device 40. The start-tag assignment prompt is a prompt for assigning a start tag 251 to the drawing 211.

In Step S102, the information processing device 40 creates first response text by using the language model on the basis of the start-tag assignment prompt and supplies the first response text to the reception unit 110. Thus, in Step S102, the information processing device 10 obtains the first response text. The first response text includes the start tag 251. Note that in the case where the processing unit 130 of the information processing device 10 has a function of performing processing using a language model, the processing unit 130 can create response text. In the case where the processing unit 130 has a function of performing processing using a language model, the processing unit 130 can create response text also in after-mentioned processing using a language model.

The details of Step S102 are described with reference to FIG. 4. First, in Step S102_1, the processing unit 130 obtains reference numerals from the drawing 211. Specifically, the processing unit 130 obtains the reference numerals "1000", "1001[1]", "1001[2]", "1001[3]", "1003[1]", "1003[2]", "1003[3]", "1011[1,1]", "1011[1,2]", "1011[1,3]", "1011[2,1]", "1011[2,2]", "1011[2,3]", "1011[3,1]", "1011[3,2]", and "1011[3,3]" illustrated in FIG. 6. The reference numerals obtained from the drawing 211 are referred to as reference numerals 212. Note that identification signs can be excluded from the reference numerals 212. In this case, the reference numerals "1000", "1001", "1003", and "1011" are the reference numerals 212. Alternatively, the reference numerals 212 may include identification signs.

In the case where the reference numeral is represented as text, the processing unit 130 can obtain the reference numeral from the drawing 211 by extracting text contained in the drawing 211. In the case where the reference numeral is represented as an image, the processing unit 130 can obtain the reference numeral from the drawing 211 by performing character recognition on the drawing 211.

Then, in Step S102_2 shown in FIG. 4, the processing unit 130 obtains a name 214 of a component denoted by the reference numeral 212 from the document 213. The name 214 can be obtained from the section [Reference numerals], for example. In the example illustrated in FIG. 6, the processing unit 130 obtains "display device" as the name of the component denoted by the reference numeral "1000". Similarly, the processing unit 130 obtains "register circuit" as the name of the component denoted by the reference numeral "1001". Moreover, the processing unit 130 obtains "latch circuit" as the name of the component denoted by the reference numeral "1003". Similarly, the processing unit 130 obtains "pixel" as the name of the component denoted by the reference numeral "1011". When a plurality of the reference numerals 212 are obtained in Step S102_1 in the above manner, the respective names 214 are obtained for the reference numerals 212. A set of the name 214 and the reference numeral 212 obtained by the processing unit 130 can be stored in the memory unit 120.

Note that the processing unit 130 may obtain the name 214 of the component denoted by the reference numeral 212 from somewhere other than the section [Reference numerals]. The processing unit 130 may acquire a word, specifically a noun, immediately before the reference numeral 212, for example, as the name 214 of the component indicated by the reference numeral 212. In this case, the processing unit 130 can obtain the name 214 by performing morphological analysis on the document 213. In the example illustrated in FIG. 6, a noun "display device" is written just before the reference numeral "1000" in the paragraph [00x1]. Thus, the name of the component denoted by the reference numeral "1000" can be determined as "display device".

Next, in Step S102_3 shown in FIG. 4, the processing unit 130 obtains, from the document 213, text 215 including the name 214 and the reference numeral 212 that are obtained in the above steps. The processing unit 130 acquires text including the above set stored in the memory unit 120 as the text 215. The text 215 can be obtained on a per-paragraph basis, for example. In the example illustrated in FIG. 6, the paragraph [00x1] includes the descriptions "display device 1000", "register circuits 1001", "latch circuits 1003", and "pixels 1011". The paragraph [00x2] includes the descriptions "register circuit 1001", "latch circuit 1003", and "pixels 1011". The paragraph [00x3] includes the description "display device 1000". Accordingly, the processing unit 130 obtains the paragraphs [00x1], [00x2], and [00x3] as the text 215. Note that the processing unit 130 does not necessarily obtain the text 215 on a per-paragraph basis. That is, only part of a paragraph may be included in the text 215. The processing unit 130 may acquire the text 215 on a per-sentence basis, for example.

Subsequently, in Step S102_4 shown in FIG. 4, the processing unit 130 obtains a representation 220 on the basis of the reference numerals 212, the names 214, and the text 215. The representation 220 is represented in a text format in a graph description language. The representation 220 indicates how the components illustrated in the drawing 211 are described in the text 215. The representation 220 may be created using a language model or may be created by the processing unit 130 without using a language model.

In this specification and the like, a graph description language refers to a language for describing graph structures. An example of a graph description language is a DOT language.

FIG. 7A is a schematic diagram illustrating an example of the representation 220. The representation 220 includes a node representation part 221 and a graph representation part 223.

The node representation part 221 includes the reference numerals 212 and the names 214. A set of one reference numeral 212 and the name 214 of a component denoted by that reference numeral 212 can be used as a node of a graph. That is, the components included in the drawing 211 illustrated in FIG. 6, specifically, the components denoted by reference numerals, can be used as nodes of the graph. In the example illustrated in FIG. 7A, the node representation part 221 includes "display device 1000", "register circuit 1001", "latch circuit 1003", and "pixel 1011". Each of the "display device 1000", "register circuit 1001", "latch circuit 1003", and "pixel 1011" can be used as a node. Regarding components marked with identification signs, components marked with different identification signs serve as different nodes. For example, the register circuit 1001[1], the register circuit 1001[2], and the register circuit 1001[3] serve as different nodes.

The graph representation part 223 indicates a connection relation between nodes included in the node representation part 221, specifically, two nodes connected to each other. The graph representation part 223 also indicates a label. A label represents a relation between two connected nodes. The graph representation part 223 can be regarded as indicating an edge. An edge includes a connection relation between nodes and a label.

As shown in FIG. 6, the text 215 reads "A register circuit 1001[1] is connected to pixels 1011[1,1], 1011[1,2], and 1011[1,3]". The graph representation part 223 illustrated in FIG. 7A represents the above as follows: register circuit 1001[1] -> pixel 1011[1,1] [label="connection"], register circuit 1001[1] -> pixel 1011[1,2] [label="connection"], and register circuit 1001[1] -> pixel 1011[1,3] [label="connection"]. In the example illustrated in FIG. 7A, the graph representation part 223 also indicates the following: register circuit 1001[2] -> pixel 1011[2,1] [label="connection"], register circuit 1001[2] -> pixel 1011[2,2] [label="connection"], register circuit 1001[2] -> pixel 1011[2,3] [label="connection"], register circuit 1001[3] -> pixel 1011[3,1] [label="connection"], register circuit 1001[3] -> pixel 1011[3,2] [label="connection"], register circuit 1001[3] -> pixel 1011[3,3] [label="connection"], latch circuit 1003[1] -> pixel 1011[1,1] [label="connection"], latch circuit 1003[1] -> pixel 1011[2,1] [label="connection"], latch circuit 1003[1] -> pixel 1011[3,1] [label="connection"], latch circuit 1003[2] -> pixel 1011[1,2] [label="connection"], latch circuit 1003[2] -> pixel 1011[2,2] [label="connection"], latch circuit 1003[2] -> pixel 1011[3,2] [label="connection"], latch circuit 1003[3] -> pixel 1011[1,3] [label="connection"], latch circuit 1003[3] -> pixel 1011[2,3] [label="connection"], and latch circuit 1003[3] -> pixel 1011[3,3] [label="connection"].

In the example illustrated in FIG. 7A, the representation 220 represents a directed graph. A directed graph is a graph whose edges have a direction. In FIG. 7A, a direction is denoted by "->". Here, an example is shown in which the representation 220 represents a directed graph with the subjects in the text 215 as source vertices. Note that the representation 220 may represent an undirected graph.

FIG. 7B is a schematic diagram illustrating a graph represented by the representation 220 shown in FIG. 7A. In the example illustrated in FIG. 7B, nodes included in the node representation part 221 are represented by ellipses. As described above, regarding components marked with identification signs, components marked with different identification signs serve as different nodes. Components marked with identification signs can be obtained from the graph representation part 223, for example.

In the graph shown in FIG. 7B, edges represented by the graph representation part 223 are indicated by arrows. Note that the labels are omitted.

The representation 220 can be created using a language model, for example. In this case, the processing unit 130 creates a representation generation prompt and transmits the prompt to the information processing device 40 through the output unit 140. The representation generation prompt is specifically transmitted to the language model of the information processing device 40. The representation generation prompt is a prompt for generating the representation 220. The representation generation prompt includes the reference numerals 212, the names 214, and the text 215. The representation generation prompt also includes instruction text such as "For the following text, describe the relation between the following terms in a DOT language. Treat the terms as nodes and make edges contain information on the relation between the terms".

In Step S102_4, the information processing device 40 creates response text by using the language model on the basis of the above-described prompt and supplies the response text to the reception unit 110. Thus, the information processing device 10 obtains the response text. The response text includes the representation 220.

Note that the representation 220 may be created without using a language model. For example, the information processing device 10 may create the representation 220. The information processing device 10 can create the representation 220 by performing morphological analysis on the text 215, for example.

Next, in Step S102_5 shown in FIG. 4, the processing unit 130 creates a start-tag assignment prompt and transmits the prompt to the information processing device 40 through the output unit 140. FIG. 8 is a schematic diagram illustrating an example of a start-tag assignment prompt.

As shown in FIG. 8, the start-tag assignment prompt includes instruction text 231, start tag candidates 241, the text 215, and the representation 220. As described above, the representation 220 can include the node representation part 221 and the graph representation part 223.

The start tag candidates 241 are candidate tags for the start tag 251 and can be listed in bullet points, for example. A tag included in the start tag candidates 241 is a tag represented as a root node of the tag tree stored in the memory unit 120. In the example illustrated in FIG. 8, "display device", "memory device", "arithmetic device", and "power storage device" are shown below the text "Tags" as the start tag candidates 241.

The instruction text 231 includes a command to select the start tag 251 from the start tag candidates 241 on the basis of the text 215 and the representation 220. In the example illustrated in FIG. 8, the instruction text 231 includes a sentence "Select the most relevant tag among the following tags on the basis of the following text and representation". The instruction text 231 can be instruction text stored in the memory unit 120.

Here, as shown in FIG. 7A, the term "pixel" appears frequently in the graph representation part 223. Moreover, the node representation part 221 includes "display device 1000". Accordingly, the language model can select "display device" as the start tag 251. Note that the start-tag assignment prompt may omit the text 215.

Accordingly, the language model can select the term related to the drawing 211 illustrated in FIG. 6 as the start tag 251. FIG. 5A illustrates an example in which the start tag 251 is "display device".

In the example illustrated in FIG. 6, the display device 1000 includes the arithmetic device, and the description of the arithmetic device is contained in the paragraph [00x3] and the subsequent paragraphs. The document 213 supposedly contains more descriptions about the arithmetic device than about the display device 1000. Meanwhile, the drawing 211, specifically the first drawing, supposedly does not show a detailed structure of the arithmetic device. In this case, if the start tag 251 is intended to be assigned to the first drawing illustrated in FIG. 6 without using the representation 220, for example, "arithmetic device" might be the start tag 251. Thus, assigning the start tag 251 to the drawing 211 by the method shown in FIG. 4 can inhibit assignment of a tag with low relevance to the drawing 211.

Next, in Step S103 shown in FIG. 3, the processing unit 130 determines whether there are any candidates for an additional tag 252. Specifically, whether a candidate for the additional tag 252 is present for the tag assigned most recently to the drawing 211 is determined. For example, in Step S103 immediately after Step S102, whether a candidate for the additional tag 252 is present for the start tag 251 is determined. The number of candidates for the additional tag 252 can be one or more. Here, specifically, whether there are one or more child nodes in a tag tree with the start tag 251 assigned to the drawing 211 as the root node is determined.

In the case where there are no candidates for the additional tag 252, the information processing method of one embodiment of the present invention is "terminated". When the information processing method of one embodiment of the present invention "terminates", the drawing 211 and the tag assigned to the drawing 211 are registered in a database. The database can be included in the memory unit 120, as described above.

In the case where there is a candidate for the additional tag 252, the processing unit 130 creates an additional-tag assignment prompt and transmits the prompt to the information processing device 40 through the output unit 140 in Step S104. The additional-tag assignment prompt is specifically transmitted to the language model of the information processing device 40. The additional-tag assignment prompt is a prompt for assigning the additional tag 252 to the drawing 211.

FIG. 9 is a schematic diagram illustrating an example of an additional-tag assignment prompt. As shown in FIG. 9, the additional-tag assignment prompt includes instruction text 232, additional tag candidates 242, the text 215, and the representation 220. The representation 220 can include the node representation part 221 and the graph representation part 223 as described above. Note that the additional-tag assignment prompt may omit the text 215, for example, like the start-tag assignment prompt.

The additional tag candidates 242 are candidate tags for the additional tag 252 and can be listed in bullet points, for example. A tag included in the additional tag candidates 242 is a tag represented as a child node of the tag assigned most recently to the drawing 211. For example, in the case where only the start tag 251 is assigned to the drawing 211 as illustrated in FIG. 5A, the tag included in the additional tag candidates 242 is a tag represented as a child node of the start tag 251. The tag represented as the child node can denote, for example, a subordinate concept of the tag represented as the parent node. In the example illustrated in FIG. 9, "AA display device", "BB display device", and "CC display device" are shown below the text "Tags" as the additional tag candidates 242.

The instruction text 232 includes a command to select the additional tag 252 from the additional tag candidates 242 on the basis of the text 215 and the representation 220. The instruction text 232 also includes a command to assign a "none" tag to the drawing 211 when the additional tag 252 cannot be selected from the additional tag candidates 242, that is, when a tag that is considered appropriate for the additional tag 252 on the basis of the text 215 and the representation 220 is not present in the additional tag candidates 242. The "none" tag can indicate that a term related to the drawing 211 is absent from the additional tag candidates 242.

In the example illustrated in FIG. 9, the instruction text 232 includes sentences "What specific kind of display device is 'display device'? Select an appropriate tag from those listed. If none are applicable, assign a 'none' tag." FIG. 9 illustrates an example of an additional-tag assignment prompt in the case where the tag represented as the parent node of the additional tag candidate 242 is "display device".

The instruction text 232 can be instruction text stored in the memory unit 120. Here, the instruction text 232 and the additional tag candidates 242 can be different for each tag. For example, in the case where the tag assigned most recently to the drawing 211 is "memory device", "arithmetic device", or "power storage device", the instruction text 232 and the additional tag candidates 242 can be different for each case from those shown in FIG. 9. For example, in the case where only the start tag 251 is assigned to the drawing 211 as illustrated in FIG. 5A and the start tag 251 is "memory device", "arithmetic device", or "power storage device", the instruction text 232 and the additional tag candidates 242 can be different for each case from those shown in FIG. 9. Note that all the instruction text 232 may contain a common sentence. For example, the sentences "Select an appropriate tag from those listed. If none are applicable, assign a 'none' tag." can be contained in all the instruction text 232.

In Step S104, the information processing device 40 creates second response text by using the language model on the basis of the additional-tag assignment prompt and supplies the second response text to the reception unit 110. Thus, in Step S104, the information processing device 10 obtains the second response text. The second response text includes the additional tag 252 or the "none" tag. The second response text can include, for example, one additional tag 252 or the "none" tag. Note that the second response text may include a plurality of additional tags 252. The processing unit 130 assigns a tag included in the second response text to the drawing 211. FIG. 5B illustrates an example in which an additional tag 252_11 is assigned to the drawing 211 as a child node of the start tag 251 illustrated in FIG. 5A. Specifically, FIG. 5B illustrates an example in which "AA display device" as the additional tag 252_11 is assigned to the drawing 211 as the child node of the start tag 251.

In FIG. 5B, an edge that connects the two nodes is indicated by an arrow. The node at the head of the arrow is the child node of the node at the tail of the arrow. In other words, the node at the tail of the arrow is the parent node of the node at the head of the arrow. FIG. 5B can be regarded as representing a tag tree. Also in the following drawings representing tag trees, an edge that connects two nodes is indicated by an arrow.

Accordingly, the additional-tag assignment prompt can be referred to as a prompt for assigning a "none" tag or at least one of the tags included in the additional tag candidates 242 to the drawing 211.

In this specification and the like, an identification sign "_i" (i is an integer greater than or equal to 1) is sometimes used to distinguish a plurality of additional tags 252.

Then, in Step S105 shown in FIG. 3, the processing unit 130 determines whether the tag assigned to the drawing 211 in Step S104 is the "none" tag. In the case where a tag other than the "none" tag is assigned to the drawing 211, that is, where the additional tag 252 is assigned to the drawing 211, the process of Step S103 is performed again. Specifically, the processing unit 130 determines whether there are any additional tag candidates 242 for the additional tag 252, and in the case where there is the additional tag candidate 242, a new additional tag 252 is assigned to the drawing 211 in Step S104. FIG. 5C illustrates an example in which an additional tag 252_12 is assigned to the drawing 211 as a child node of the additional tag 252_11 illustrated in FIG. 5B. Specifically, FIG. 5C illustrates an example in which "DDD" as the additional tag 252_12 is assigned to the drawing 211 as the child node of the additional tag 252_11.

In the above manner, Step S104 is repeated until there are no more additional tag candidates 242 or a "none" tag is assigned to the drawing 211. Here, examples of the case where there are no more additional tag candidates 242 include the case where the last-assigned additional tag 252 is a tag represented as a leaf node. Note that a leaf node refers to a node that has no child nodes.

In the case where the "none" tag is assigned to the drawing 211, the processing unit 130 determines, in Step S106 shown in FIG. 3, whether there are any instruction text candidates for an additional-tag-candidate presentation prompt. An additional-tag-candidate presentation prompt is created in the next Step S107. For example, whether an instruction text candidate for an additional-tag-candidate presentation prompt is stored in the memory unit 120 is determined. The instruction text candidate is candidate instruction text serving as later-described instruction text 233. The instruction text 233, which will be described in detail later, includes a perspective for presenting a new additional tag candidate.

In the case where there are no instruction text candidates, the information processing method of one embodiment of the present invention is "terminated". In the case where there is an instruction text candidate, the processing unit 130 creates an additional-tag-candidate presentation prompt and transmits the prompt to the information processing device 40 through the output unit 140 in Step S107. The additional-tag-candidate presentation prompt is specifically transmitted to the language model of the information processing device 40. The additional-tag-candidate presentation prompt is a prompt for presenting a candidate for a new additional tag 252 on the basis of the tag assigned just before the assignment of the "none" tag, i.e., the most recently assigned tag excluding the "none" tag.

Specifically, in the case where a "none" tag is assigned in the state where only the start tag 251 is assigned to the drawing 211 as illustrated in FIG. 5A, a candidate for a new additional tag 252 is presented on the basis of the start tag 251. In the case where a "none" tag is assigned in the state where the tag tree illustrated in FIG. 5B is assigned to the drawing 211, a candidate for a new additional tag 252 is presented on the basis of the additional tag 252_11. Furthermore, in the case where a "none" tag is assigned in the state where the tag tree illustrated in FIG. 5C is assigned to the drawing 211, a candidate for a new additional tag 252 is presented on the basis of the additional tag 252_12. An example in which a candidate for a new additional tag 252 is presented on the basis of the start tag 251 illustrated in FIG. 5A is described below.

FIG. 10 is a schematic diagram illustrating an example of an additional-tag-candidate presentation prompt. As shown in FIG. 10, the additional-tag-candidate presentation prompt includes the instruction text 233, the text 215, and the representation 220. The representation 220 can include the node representation part 221 and the graph representation part 223 as described above. Note that the additional-tag-candidate presentation prompt may omit the representation 220, for example.

The instruction text 233 includes a command to present a candidate for the additional tag 252 on the basis of the text 215 and the representation 220. The instruction text 233 also includes a perspective for presenting a candidate for the additional tag 252. Furthermore, the instruction text 233 includes a command to present a notification when a candidate for the additional tag 252 based on the text 215 and the representation 220 cannot be presented. In the example illustrated in FIG. 10, the instruction text 233 contains sentences "Enumerate the constituent parts of 'display device' in consideration of functionality. Provide the answer in a bulleted list. If not feasible, indicate 'Unable to provide'." In this case, "function", for example, is a perspective for presenting a candidate for the additional tag 252. FIG. 10 illustrates an example of an additional-tag-candidate presentation prompt in the case where the tag that is assigned to the drawing 211 just before the assignment of a "none" tag is "display device".

The instruction text 233 can be instruction text stored in the memory unit 120. Here, different pieces of instruction text 233 can be linked to respective tags stored in the memory unit 120. There may be a tag to which a plurality of pieces of instruction text 233 are linked, or a tag to which no instruction text 233 is linked. Note that all the instruction text 233 may include a common sentence. Specifically, text that includes neither the tag nor the above-described perspective can be common to all the instruction text 233. In the example illustrated in FIG. 10, the sentences "Provide the answer in a bulleted list. If not feasible, indicate 'Unable to provide'." can be included in all the instruction text 233.

In the case where a plurality of pieces of instruction text 233 are linked to a tag assigned just before the assignment of a "none" tag, any one piece of the instruction text 233 is included in the additional-tag-candidate presentation prompt. As described above, for example, in the case where a "none" tag is assigned in the state where only the start tag 251 illustrated in FIG. 5A is assigned to the drawing 211, the start tag 251 corresponds to a tag assigned just before the assignment of the "none" tag. In the case where a "none" tag is assigned in the state where the tag tree illustrated in FIG. 5B is assigned to the drawing 211, the additional tag 252_11 corresponds to a tag assigned just before the assignment of the "none" tag. In the case where a "none" tag is assigned in the state where the tag tree illustrated in FIG. 5C is assigned to the drawing 211, the additional tag 252_12 corresponds to a tag assigned just before the assignment of the "none" tag.

The instruction text 233 included in the additional-tag-candidate presentation prompt may be automatically selected by the processing unit 130 or may be selected by the user of the information processing system. Note that in the case where the instruction text 233 is not linked to the tag assigned just before the assignment of a "none" tag, Step S106 described above determines that there are no instruction text candidates. Thus, the information processing method of one embodiment of the present invention "terminates".

In Step S107, the information processing device 40 creates third response text by using the language model on the basis of the additional-tag-candidate presentation prompt and supplies the third response text to the reception unit 110. Thus, in Step S107, the information processing device 10 obtains the third response text. The third response text contains a candidate for the additional tag 252. In the case where a candidate for the additional tag 252 based on the text 215 and the representation 220 cannot be presented, the third response text indicates "Unable to provide".

Next, the processing unit 130 executes the process of Step S103 in FIG. 3 again. Here, the case where the third response text indicates "Unable to provide" signifies that there are no candidates for the additional tag 252; subsequently, the information processing method of one embodiment of the present invention is "terminated". In the case where the third response text includes a candidate for the additional tag 252, the process of Step S104 is performed again. FIG. 5D illustrates an example in which "part DD" is assigned to the drawing 211 as the additional tag 252_11 in Step S104. FIG. 5E illustrates an example in which the additional tag 252_11 shown in FIG. 5D is assigned to the drawing 211 and then Step S103 determines that there is another additional tag candidate 242 for the additional tag 252_11. FIG. 5E illustrates an example in which "EEE" is assigned to the drawing 211 as the additional tag 252_12 in Step S104.

Here, the instruction text 232 shown in FIG. 9 can include text indicating that a "none" tag is to be assigned to the drawing 211 when the additional tag 252 cannot be selected from the additional tag candidates 242, in addition to text similar to the instruction text 231 shown in FIG. 8, for example.

Accordingly, the tag group having a tree structure is assigned to the drawing 211. The drawing 211 and the tags assigned to the drawing are registered in the database, as described above.

In the above manner, in the information processing method of one embodiment of the present invention, a tag group having a tree structure is assigned to the drawing 211 with the use of a language model and registered in a database. Accordingly, the tags can be assigned with a smaller workload than in the case where a tag group having a tree structure is assigned manually, for example. Moreover, tagging by the information processing method of one embodiment of the present invention enables comprehensive coverage of terms related to the drawing, unlike non-hierarchical tagging, for example.

Even when a "none" tag is assigned to the drawing 211, preparing the instruction text 233 that represents a tagging perspective enables tag assignment to the drawing 211 without preparing a tag corresponding to the perspective presented by the instruction text 233 (a candidate for the additional tag 252). Thus, even for a perspective for which preparation of a candidate for the additional tag 252 is difficult, a tag corresponding to the perspective can be assigned to the drawing 211.

The example in which the first drawing illustrated in FIG. 6 is tagged has been described above; in the case where the data 210 includes a plurality of drawings 211 (a second drawing, a third drawing, and the like), for example, each of the drawings 211 can be tagged by being subjected to the processes shown in FIG. 3 and the like.

The user of the information processing system of one embodiment of the present invention can search for the drawing 211 with the use of a tag. For example, the drawing 211 to which a tag including a keyword specified by the user is assigned can be searched and presented to the user. Moreover, the data 210 including the retrieved drawing 211 can be presented. As described above, tags can be assigned to the drawing 211 so as to comprehensively cover terms related to the drawing 211. Accordingly, the information processing system of one embodiment of the present invention can perform highly convenient searches.

As described above, the information processing system of one embodiment of the present invention can be regarded as including a tagging system and a search system. In this case, the tagging system has a function of assigning tags, specifically a tag group having a tree structure, to the drawing 211. The search system has a function of searching for the drawing 211 with the use of the assigned tags. Note that the tagging system may be considered to be the information processing system of one embodiment of the present invention, as has been described.

Accordingly, one embodiment of the present invention can provide an information processing system that is highly convenient and useful. One embodiment of the present invention can also provide an information processing device included in the information processing system and an information processing method using the information processing system.

### Information processing method 2

FIG. 11 is a flow chart showing another example of the information processing method of one embodiment of the present invention, which is different from that in FIG. 3. In FIG. 11, steps different from the steps included in the information processing method shown in FIG. 3 are indicated by thick borders. Note that the same steps as the steps included in the information processing method shown in FIG. 3 are denoted by the same reference numerals.

In the information processing method shown in FIG. 11, a tag group having a tree structure is assigned to the drawing 211. FIGS. 12A to 12C and FIG. 13 are schematic diagrams for describing tag assignment to the drawing 211 in the information processing method shown in FIG. 11.

When the information processing method shown in FIG. 11 "starts", the processes of Steps S101 to S105 are performed. In the case where Step S105 determines that a tag other than a "none" tag is assigned to the drawing 211, the process of Step S103 is performed again as described above.

In the case where Step S103 determines that there are no candidates for the additional tag 252 and in the case where Step S105 determines that a "none" tag is assigned to the drawing 211, the processing unit 130 obtains text 219 from the document 213 in Step S111 shown in FIG. 11. In other words, the processing unit 130 extracts at least part of the document 213 and designates the extracted text as the text 219. The text 219 can include the text 215 shown in FIG. 6, for example. The text 219 will be described in detail later. Note that in the information processing method shown in FIG. 11, the processes of Steps S106 and S107 shown in FIG. 3 are not performed.

Next, in Step S112, the processing unit 130 creates a perspective presentation prompt and transmits the prompt to the information processing device 40 through the output unit 140. The perspective presentation prompt is specifically transmitted to the language model of the information processing device 40. The perspective presentation prompt is a prompt for presenting a tagging perspective on the basis of the text 219.

FIG. 14 is a schematic diagram illustrating an example of a perspective presentation prompt. As shown in FIG. 14, the perspective presentation prompt includes instruction text 234, the text 219, tags 244, and text 230. FIG. 14 illustrates an example of a perspective presentation prompt in the case where a tag tree shown in FIG. 12A is assigned to the drawing 211. In the example illustrated in FIG. 12A, the start tag 251, the additional tag 252_11, the additional tag 252_12, and an additional tag 252_13 are assigned to the drawing 211. In the example of FIG. 12A, the additional tag 252_11 is a child node of the start tag 251, the additional tag 252_12 is a child node of the additional tag 252_11, and the additional tag 252_13 is a child node of the additional tag 252_12. Furthermore, in the example of FIG. 12A, the start tag 251 is "display device", the additional tag 252_11 is "AA display device", the additional tag 252_12 is "DDD", and the additional tag 252_13 is "D1D2D3".

As shown in FIG. 14, the text 219 can include the text 215. Moreover, the text 219 can include at least part of the document 213 shown in FIG. 6 in addition to the text 215. In the example illustrated in FIG. 14, the text 219 contains text that describes the purpose of the invention, design, or research disclosed in the document 213 shown in FIG. 6. FIG. 14 illustrates an example in which the text 219 includes the section [Problems to be Solved by the Invention]. The text 219 can be obtained on a per-paragraph basis, for example. Note that the processing unit 130 does not necessarily obtain the text 219 on a per-paragraph basis. That is, only part of a paragraph may be included in the text 219. The processing unit 130 may acquire the text 219 on a per-sentence basis, for example. Note that the text 219 may be specified by the user of the information processing system.

The tags 244 represent tags that have been assigned to the drawing 211. In the example illustrated in FIG. 14, "display device", "AA display device", "DDD", and "D1D2D3" are shown as the tags 244. These four tags 244 are tags constituting the tag tree illustrated in FIG. 12A.

Here, all the tags 244 are not necessarily included in the perspective presentation prompt. That is, some of the tags 244 may be omitted from the perspective presentation prompt. For example, the start tag 251 may be omitted from the perspective presentation prompt. The start tag 251 and some of the additional tags 252 may alternatively be omitted from the perspective presentation prompt. In such cases, the perspective presentation prompt can include a predetermined additional tag 252 and the additional tag 252 represented as a descendant node of the predetermined additional tag 252. For example, in the case where the start tag 251 and the additional tag 252_11 are omitted from the perspective presentation prompt in the example of FIG. 12A, the perspective presentation prompt can include the additional tag 252_12 and the additional tag 252_13, which is the descendant node of the additional tag 252_12, among the tags illustrated in FIG. 12A. In this case, it can be said that the perspective presentation prompt includes a subtree composed of the additional tag 252_12 and the additional tag 252_13 among the four tags shown in FIG. 12A, specifically the tags forming the subtree.

Preferably, the tag 244 serving as a root node among the tags 244 included in the perspective presentation prompt is clearly indicated as the root node. For example, in the case where the perspective presentation prompt includes the start tag 251 and the additional tags 252_11 to 252_13 illustrated in FIG. 12A, it is preferable to clearly indicate that the start tag 251 is the root node. For another example, in the case where the perspective presentation prompt includes the additional tags 252_12 and 252_13 but not the start tag 251 or the additional tag 252_11, it is preferable to clearly indicate that the additional tag 252_12 is the root node. In the case where the additional tag 252_12 serves as the root node, the root node corresponds to a root node of a subtree included in the tag tree shown in FIG. 12A, for example. In the example illustrated in FIG. 14, (root node) is given to indicate that tag "display device" is the root node. Here, the tag 244 serving as the root node can be specified by the user of the information processing system, for example.

The text 230 shows, as exclusion instruction text, the instruction text for the prompt used to assign the tag 244 included in the perspective presentation prompt to the drawing 211. In the example illustrated in FIG. 14, the instruction text 232 shown in FIG. 9 is used as the exclusion instruction text. Here, in the case where there are a plurality of pieces of exclusion instruction text, they can be listed in bullet points. Note that the instruction text for the prompt used to assign the tag 244 indicated as the root node to the drawing 211 can be omitted from the text 230. For example, the instruction text 231 for the start-tag assignment prompt shown in FIG. 8 can be omitted from the text 230.

The instruction text 234 includes a command to present a new tagging perspective on the basis of the text 219 when a new tag other than the tag 244 is to be assigned to the drawing 211. The instruction text 234 also includes a command not to present a tagging perspective included in the text 230, that is, a command not to incorporate a tagging perspective included in the text 230 in the aforementioned new tagging perspective. Furthermore, the instruction text 234 includes a command to present a notification when a new tagging perspective cannot be presented. In the example illustrated in FIG. 14, the instruction text 234 contains sentences "The following tags have been assigned. For further tagging, what perspectives would be useful? Provide a perspective on the basis of the text shown below while excluding the perspective represented in the following exclusion instruction text. If not feasible, indicate 'No perspective'."

In Step S112, the information processing device 40 creates fourth response text by using the language model on the basis of the perspective presentation prompt and supplies the fourth response text to the reception unit 110. Thus, in Step S112, the information processing device 10 obtains the fourth response text. The fourth response text can include a new tagging perspective. For example, in the case where the text 219 contains text that describes the purpose of the invention, design, or research disclosed in the document 213 shown in FIG. 6, a tagging perspective based on the purpose can be included in the fourth response text. Alternatively, the fourth response text can indicate that a new tagging perspective cannot be presented, and for example, can indicate that a perspective other than the perspective included in the text 230 cannot be presented. For example, "type of display device" can be regarded as the perspective included in the text 230.

Then, in Step S113 shown in FIG. 11, the processing unit 130 determines whether a new tagging perspective is presented. Specifically, the processing unit 130 determines whether a new tagging perspective is included in the fourth response text. In the case where a new tagging perspective is not presented, specifically, in the case where the fourth response text indicates that a new tagging perspective cannot be presented, the information processing method shown in FIG. 11 is "terminated". In the case where a new tagging perspective is presented, the processing unit 130 creates a tag-tree presentation prompt and transmits the prompt to the information processing device 40 through the output unit 140 in Step S114. The tag-tree presentation prompt is specifically transmitted to the language model of the information processing device 40.

The tag-tree presentation prompt is a prompt for presenting at least one tag candidate on the basis of the new tagging perspective which the processing unit 130 acquires in Step S112. The at least one tag candidate can be represented as a descendant node of the tag 244 indicated as the root node. In the case where the processing unit 130 creates the perspective presentation prompt shown in FIG. 14 in Step S112, the tag candidate is a tag that can be represented as a descendant node of the tag "display device". Accordingly, the tag-tree presentation prompt is a prompt for presenting a new tag tree with one of the tags 244 as a root node. In the tag tree, the nodes other than the root node, that is, the descendant nodes of the root node, can be tags that are not included in the tags 244.

FIG. 15 is a schematic diagram illustrating an example of a tag-tree presentation prompt. As shown in FIG. 15, the tag-tree presentation prompt includes instruction text 235 and a tagging perspective 261. Here, the tagging perspective 261 corresponds to the new tagging perspective which the processing unit 130 obtains in Step S112.

The instruction text 235 includes a command to present a tag candidate on the basis of the tagging perspective 261. The instruction text 235 also includes a command to present the tag candidate in a tree structure where the tag 244 indicated as the root node in the perspective presentation prompt is used as the root node. In the example illustrated in FIG. 15, the instruction text 235 includes sentences "Present tag candidates on the basis of the following perspective. Present the tag candidates in a tree structure with 'display device' as the root node." FIG. 15 shows an example of the tag-tree presentation prompt in the case where the tag 244 indicated as the root node in the perspective presentation prompt is "display device".

In Step S114, the information processing device 40 creates fifth response text by using the language model on the basis of the tag-tree presentation prompt and supplies the fifth response text to the reception unit 110. Thus, in Step S114, the information processing device 10 obtains the fifth response text. The fifth response text can include a tag tree. The root node of the tag tree can be, for example, the tag 244 indicated as the root node in the perspective presentation prompt. The tag tree can be represented, for example, by a graph description language such as a DOT language. The tag tree can be stored in the memory unit 120, for example.

Descendant nodes of the root node in the tag tree represented by the fifth response text are tag candidates. Note that the fifth response text may sometimes not contain any tag candidates. In the case where the fifth response text does not contain a tag candidate, the fifth response text can indicate that a tag candidate cannot be presented.

Next, the processing unit 130 executes the process of Step S103 in FIG. 11 again. In Step S103 immediately after Step S114, among the tag candidates included in the fifth response text, a child node of the root node can be a candidate for the additional tag 252. FIG. 12B illustrates an example in which an additional tag 252_21 is assigned to the drawing 211 in Step S104 immediately after Step S103. In the example illustrated in FIG. 12B, the additional tag 252_21 is "FFF" and is assigned to the drawing 211 as a child node of the start tag 251. In the example of FIG. 12B, the additional tag 252_11 and the additional tag 252_21 are sibling nodes. The tagging perspective differs between the additional tag 252_11 and the additional tag 252_21.

In the case where Step S105 shown in FIG. 11 determines that a tag other than the "none" tag is assigned to the drawing 211, i.e., that the additional tag 252 is assigned to the drawing 211, the process of Step S103 is performed again as described above. Here, among the tag candidates included in the fifth response text, a child node of the tag assigned most recently to the drawing 211 can be a candidate for the additional tag 252. In the example of FIG. 12B, among the tag candidates included in the fifth response text, a child node of the tag "FFF" can be a candidate for the additional tag 252.

FIG. 12C illustrates an example in which the additional tag 252_21 shown in FIG. 12B is assigned to the drawing 211 and then an additional tag 252_22 is assigned to the drawing 211. FIG. 12C specifically illustrates an example in which "F1F2F3" is assigned to the drawing 211 as the additional tag 252_22. In the example of FIG. 12C, the additional tag 252_22 is assigned as a child node of the additional tag 252_21.

As described above, Step S104 is repeated until there are no more additional tag candidates 242 or a "none" tag is assigned to the drawing 211. Here, examples of the case where there are no more candidates for the additional tag 252 include the case where the most recently assigned tag is a tag represented as a leaf node among the tag candidates included in the fifth response text. The processes shown in FIG. 11 are executed until a new tagging perspective is not presented in Step S112. That is, assignment of the additional tag 252 to the drawing 211, for example, is performed until a new tagging perspective is not presented.

FIG. 13 illustrates an example in which Steps S111 to S114 in FIG. 11 are performed after the assignment of the additional tag 252_22 shown in FIG. 12C to the drawing 211, and then an additional tag 252_23 is assigned to the drawing 211 in Steps S103 and S104. In the example illustrated in FIG. 13, the additional tag 252_23 is "F4F5F6" and is assigned to the drawing 211 as a child node of the additional tag 252_21. In the example of FIG. 13, the additional tag 252_22 and the additional tag 252_23 are sibling nodes. The tagging perspective differs between the additional tag 252_22 and the additional tag 252_23.

In the case where the additional tag 252_23 shown in FIG. 13 is added to the tag tree shown in FIG. 12C, the additional tags 252_21 and 252_22 are included as the tags 244 in the perspective presentation prompt, which the processing unit 130 creates in Step S112. Preferably, the perspective presentation prompt clearly indicates that the additional tag 252_21, that is, the tag "FFF", is the tag 244 serving as the root node. Note that in the case where the additional tag 252_23 shown in FIG. 13 is added to the tag tree shown in FIG. 12C, it is preferable that the start tag 251 and the additional tags 252_11, 252_12, and 252_13 not be included in the perspective presentation prompt.

In the case where the additional tag 252_23 shown in FIG. 13 is added to the tag tree shown in FIG. 12C, instruction text for the prompt used to assign the additional tag 252_22 is incorporated in the perspective presentation prompt as the text 230. Specifically, in Step S104, the instruction text 232 for the additional-tag assignment prompt used to assign the additional tag 252_22 is incorporated in the text 230.

In the case where a new tagging perspective is not presented in Step S112 after the additional tag 252_23 is assigned to the drawing 211, the start tag 251 and the additional tags 252 illustrated in FIG. 13 are registered in the database as the tags assigned to the drawing 211. That is, "display device", "AA display device", "DDD", "D1D2D3", "FFF", "F1F2F3", and "F4F5F6" are registered in the database as the tags assigned to the drawing 211.

With the information processing method shown in FIG. 11, the additional tags 252 can be assigned to the drawing 211 on the basis of a plurality of perspectives. At least some of the plurality of perspectives can be presented by the language model, not by the user of the information processing system. Thus, at least some of the additional tags 252 can be based on a perspective that the user has not considered. Consequently, the tags can be assigned so as to comprehensively cover terms related to the drawing from a variety of perspectives. This allows the user of the information processing system to search for the drawing 211 from a variety of perspectives. Accordingly, tag assignment to the drawing 211 using the information processing method shown in FIG. 11 enables the information processing system to perform highly convenient searches.

### Structure example 2 of information processing system

A detailed structure example of the information processing system of one embodiment of the present invention is described below. Specifically, structure examples of the memory unit 120, the processing unit 130, and the network 30 that are not shown in <Structure example 1 of information processing system> are described.

The memory unit 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory. The memory unit 120 may include at least one of a NOSRAM (registered trademark) and a DOSRAM (registered trademark). The memory unit 120 may include a recording media drive. Examples of the recording media drive include a hard disk drive (HDD) and a solid-state drive (SSD).

Note that "NOSRAM" is an abbreviation for "nonvolatile oxide semiconductor random access memory". The NOSRAM refers to a memory in which a two-transistor (2T) or three-transistor (3T) gain cell is used as a memory cell and each transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells with the use of the characteristics of an extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers; hence, a semiconductor device in which the NOSRAM is used for a large-scale cache memory, a large-scale main memory, a large-scale storage memory, or the like can have higher performance.

The DOSRAM is an abbreviation for "dynamic oxide semiconductor RAM" and refers to a RAM including a one-transistor (1T) and one-capacitor (1C) memory cell. The DOSRAM is a DRAM formed using an OS transistor and temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is referred to as an oxide semiconductor in some cases.

A metal oxide included in a channel formation region preferably contains indium (In), and for example, indium oxide is preferably used. When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., zinc tin oxide or gallium tin oxide).

The processing unit 130 can include an arithmetic circuit, for example. The processing unit 130 can include, for example, a central processing unit (CPU). The processing unit 130 can also include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. The processing unit 130 can perform various data processes and program controls by interpreting and executing commands from various kinds of programs by a processor. The programs to be executed by the processor are stored in at least one of the memory unit 120 and a memory region of the processor.

The processing unit 130 may include a main memory. The main memory includes at least one of a volatile memory such as a random access memory (RAM) and a nonvolatile memory such as a read only memory (ROM). The main memory may include at least one of the above-described NOSRAM and DOSRAM.

Examples of the RAM include a DRAM and an SRAM; a virtual memory space is assigned and utilized as a working space of the processing unit 130. An operating system, an application program, a program module, program data, a look-up table, and the like that are stored in the memory unit 120 are loaded into the RAM for execution. The data, program, and program module that are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultraviolet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (a Si transistor).

The processing unit 130 preferably includes an OS transistor. Since the OS transistor has an extremely low off-state current, a long data retention period can be ensured with the use of the OS transistor as a switch for retaining electric charge (data) that has flowed into a capacitor functioning as a memory element. When at least one of a register and a cache memory included in the processing unit 130 has such a feature, the processing unit 130 can be operated only when needed, and otherwise can be turned off after information on the immediately preceding process is stored in the memory element. In other words, normally-off computing is possible and the power consumption of the information processing system can be reduced.

As the network 30, the Internet, which is a global network and works as the infrastructure of the World Wide Web (WWW), can be used, for example. Moreover, a local network can be used as the network 30. An intranet or an extranet can be used as the network 30. A personal area network (PAN), a local area network (LAN), a campus area network (CAN), a metropolitan area network (MAN), a wide area network (WAN), a global area network (GAN), or the like can be used as the network 30.

In the case where a service provider using the information processing method of one embodiment of the present invention and the user who enjoys the service belong to the same organization such as a company, data transmission and reception between the information terminal 20 and the information processing device 10 is preferably performed using a network constructed in the organization, for example. Thus, data can be transmitted and received between the information terminal 20 and the information processing device 10 more safely than in the case where data is transmitted via the Internet. In addition, confidential information in the organization can be prevented from leaking to the outside.

Note that as communication protocols or communication technology for wireless communication, it is possible to use communication standards such as the fourth-generation mobile communication system (4G), the fifth-generation mobile communication system (5G), or the sixth-generation mobile communication system (6G); or communication standards developed by the Institute of Electrical and Electronics Engineers (IEEE), such as Wi-Fi (registered trademark) or Bluetooth (registered trademark).

This application is based on Japanese Patent Application Serial No. 2025-075038 filed with Japan Patent Office on April 29, 2025, the entire contents of which are hereby incorporated by reference.

What is claimed is:

1. An information processing method comprising:
a first step; a second step; a third step; and a fourth step,
wherein in the first step, a drawing and a document are received,
wherein in the second step, a first prompt for assigning a start tag to the drawing based on the document is created and transmitted to a large language model,
wherein the start tag represents a term related to the drawing,
wherein in the third step, a second prompt for assigning a none tag or an additional tag of a plurality of tag candidates based on the start tag to the drawing is created and transmitted to the large language model,
wherein the none tag indicates that a term related to the drawing is absent from the plurality of tag candidates, and
wherein, when the none tag is assigned to the drawing, a third prompt for presenting a new additional tag candidate for the plurality of tag candidates based on the start tag is created and transmitted to the large language model in the fourth step, and then the third step is performed again.

2. The information processing method according to claim 1, further comprising:
a fifth step of obtaining a reference numeral from the drawing;
a sixth step of obtaining, from the document, a name of a component denoted by the reference numeral;
a seventh step of obtaining, from the document, text comprising the name and the reference numeral; and
an eighth step of obtaining a representation by using a graph description language based on the reference numeral, the name, and the text,
wherein the fifth step, the sixth step, the seventh step, and the eighth step are performed between the first step and the second step,
wherein the representation comprises a graph comprising at least two nodes and at least one edge,
wherein one of the at least two nodes represents the component,
wherein the edge represents a relation between the at least two nodes, and
wherein the first prompt comprises the text and the representation.

3. The information processing method according to claim 2,
wherein in the eighth step, the representation is obtained by creating a fourth prompt for generating the representation and transmitting the fourth prompt to the large language model.

4. An information processing method comprising:
a first step; a second step; a third step; a fourth step; a fifth step; a sixth step; a seventh step; and an eighth step,
wherein in the first step, a drawing and a document are received,
wherein in the second step, a first prompt for assigning a start tag to the drawing based on the document is created and transmitted to a language model,
wherein the start tag represents a term related to the drawing,
wherein in the third step, a second prompt for assigning a first none tag or at least a first additional tag of a plurality of first additional tag candidates based on the start tag to the drawing is created and transmitted to the language model,
wherein the first none tag indicates that a term related to the drawing is absent from the plurality of first additional tag candidates,
wherein, when at least the first additional tag is assigned as an additional tag to the drawing, a third prompt for assigning a second none tag or at least a second additional tag of a plurality of second additional tag candidates based on the additional tag to the drawing is created and transmitted to the language model in the fourth step,
wherein the second none tag indicates that a term related to the drawing is absent from the plurality of second additional tag candidates,
wherein, when the first none tag is assigned to the drawing, a fourth prompt for presenting a third additional tag of a plurality of third additional tag candidates based on the start tag is created and transmitted to the language model in the fifth step, and then a fifth prompt for assigning a third none tag or at least the third additional tag of the plurality of third additional tag candidates is created and transmitted to the language model in the sixth step,
wherein the third none tag indicates that a term related to the drawing is absent from the plurality of third additional tag candidates,
wherein, when the second none tag is assigned to the drawing, a sixth prompt for presenting a fourth additional tag of a plurality of fourth additional tag candidates based on the additional tag is created and transmitted to the language model in the seventh step, and then a seventh prompt for assigning a fourth none tag or at least the fourth additional tag of the plurality of fourth additional tag candidates is created and transmitted to the language model in the eighth step, and
wherein the fourth none tag indicates that a term related to the drawing is absent from the plurality of fourth additional tag candidates.

5. The information processing method according to claim 4, further comprising:
a ninth step of obtaining a reference numeral from the drawing;
a tenth step of obtaining, from the document, a name of a component denoted by the reference numeral;
an eleventh step of obtaining, from the document, text comprising the name and the reference numeral; and
a twelfth step of obtaining a representation by using a graph description language based on the reference numeral, the name, and the text,
wherein the ninth step, the tenth step, the eleventh step, and the twelfth step are performed between the first step and the second step,
wherein the representation represents a graph comprising at least two nodes and at least one edge,
wherein one of the at least two nodes represents the component,
wherein the edge represents a relation between the at least two nodes, and
wherein the first prompt comprises the text and the representation.

6. The information processing method according to claim 5,
wherein in the twelfth step, the representation is obtained by creating an eighth prompt for generating the representation and transmitting the eighth prompt to the language model.

7. The information processing method according to claim 1,
wherein the document is a specification for a patent application, and
wherein the drawing is a drawing for the patent application.

8. An information processing method comprising:
a first step; a second step; a third step; a fourth step; a fifth step; a sixth step; and a seventh step,
wherein in the first step, a drawing and a document are received,
wherein in the second step, a first prompt for assigning a start tag to the drawing is created based on the document and is transmitted to a language model,
wherein the start tag represents a term related to the drawing,
wherein in the third step, a second prompt for assigning a first tag or at least one of first additional tag candidates based on the start tag to the drawing is created and transmitted to the language model,
wherein the first tag indicates that terms related to the drawing are absent from the first additional tag candidates,
wherein when the first tag is assigned to the drawing, the fourth step, the fifth step, the sixth step, and the seventh step are performed,
wherein in the fourth step, a first text is obtained from the document,
wherein in the fifth step, a third prompt for presenting a first tagging perspective based on the first text is created and transmitted to the language model,
wherein in the sixth step, a fourth prompt for presenting, based on the first tagging perspective, at least one first tag candidate in a tree structure using a tag assigned to the drawing as a first root node is created and transmitted to the language model, and
wherein in the seventh step, a fifth prompt for assigning at least one second additional tag candidate represented as a child node of the first root node to the drawing as a first additional tag is created and transmitted to the language model.

9. The information processing method according to claim 8,
wherein the second prompt is a prompt for assigning at least one of the first additional tag candidates or the first tag to the drawing based on a second tagging perspective different from the first tagging perspective, and
wherein an instruction text for the third prompt comprises a command not to incorporate the second tagging perspective in the first tagging perspective.

10. The information processing method according to claim 8, further comprising:
an eighth step; a ninth step; a tenth step; an eleventh step; and a twelfth step,
wherein in the eighth step, a sixth prompt for assigning a second tag or at least one of third additional tag candidates represented as child nodes of the first additional node to the drawing is created and transmitted to the language model,
wherein the second tag indicates that terms related to the drawing are absent from the third additional tag candidates,
wherein when the second tag is assigned to the drawing, the ninth step, the tenth step, the eleventh step, and the twelfth step are performed,
wherein in the ninth step, the first text is obtained,
wherein in the tenth step, a seventh prompt for presenting a second tagging perspective based on the first text is created and transmitted to the language model,
wherein in the eleventh step, an eighth prompt for presenting, based on the second tagging perspective, at least one second tag candidate in a tree structure using a tag assigned to the drawing as a second root node is created and transmitted to the language model, and
wherein in the twelfth step, a ninth prompt for assigning at least one fourth additional tag candidate represented as a child node of the second root node to the drawing as a second additional tag is created and transmitted to the language model.

11. The information processing method according to claim 10,
wherein the second prompt is a prompt for assigning at least one of the first additional tag candidates or the first tag to the drawing based on a third tagging perspective different from the first tagging perspective and the second tagging perspective,
wherein a first instruction text for the third prompt comprises a command not to incorporate the third tagging perspective in the first tagging perspective, and
wherein a second instruction text for the seventh prompt comprises a command not to incorporate the first tagging perspective and the third tagging perspective in the second tagging perspective.

12. The information processing method according to claim 8, further comprising:
an eighth step of obtaining a reference numeral from the drawing;
a ninth step of obtaining, from the document, a name of a component denoted by the reference numeral;
a tenth step of obtaining, from the document, second text comprising the name and the reference numeral; and
an eleventh step of obtaining a representation by using a graph description language based on the reference numeral, the name, and the second text,
wherein the eighth step, the ninth step, the tenth step, and the eleventh step are performed between the first step and the second step,
wherein the representation represents a graph comprising at least two nodes and at least one edge,
wherein one of the at least two nodes represents the component,
wherein the edge represents a relation between the at least two nodes, and
wherein the first prompt comprises the second text and the representation.

13. The information processing method according to claim 12,
wherein the first text comprises the second text.

14. The information processing method according to claim 13,
wherein the first text comprises a text describing a purpose.

15. The information processing method according to claim 14,
wherein the document is a specification for a patent application,
wherein the drawing is a drawing for the patent application, and
wherein the text describing the purpose comprises an object described in SUMMARY OF THE INVENTION.

16. The information processing method according to claim 12,
wherein in the eleventh step, the representation is obtained by creating a sixth prompt for generating the representation and transmitting the sixth prompt to the language model.

17. The information processing method according to claim 2,
wherein the graph description language is a DOT language.
